(19) United States
(12) Patent Application Publication
(10) Pub. No.: US 2015/0147677 A1
(43) Pub. Date: May 28, 2015

(54) FABRICATION OF SOLID OXIDE FUEL CELLS WITH A THIN (LA0.9SR0.1)0.98(GA0.8MG0.2)O3-delta ELECTROLYTE ON A SR0.8LA0.2TIO3 SUPPORT

(71) Applicant: Northwestern University, Evanston, IL (US)

(72) Inventors: Scott A. Barnett, Evanston, IL (US); Zhan Gao, Evanston, IL (US); Elizabeth C. Miller, Chicago, IL (US)

(21) Appl. No.: 14/556,081

(22) Filed: Nov. 28, 2014

Related U.S. Application Data
(60) Provisional application No. 61/909,895, filed on Nov. 27, 2013.

(51) Int. Cl. H01M 8/10; C04B 35/645; C04B 35/64; C04B 35/47

(52) U.S. Cl. CPC H01M 8/1097; C04B 35/47; C04B 35/6455; C04B 35/64; H01M 2008/1293
USPC 429/495; 156/242; 264/43; 264/620; 156/89.14

(57) ABSTRACT

Methods and compositions for a low temperature operating solid oxide fuel cell (SOFC) are provided. The SOFC includes a Sr_{0.8}La_{0.2}TiO₃ (SLT) support layer, a (La_{0.9}Sr_{0.1})_{0.98}(Ga_{0.8}Mg_{0.2})O_{3-δ} (LSGM) electrolyte layer and□a cathode layer disposed on top of said electrolyte layer.

### CROSS-REFERENCE TO RELATED APPLICATIONS

This application claims benefit of priority under 35 U.S.C. 119 to U.S. provisional patent application Ser. No. 61/909,895, filed Nov. 27, 2013, and entitled “FABRICATION OF SOLID OXIDE FUEL CELLS WITH A THIN (La_{0.9}Sr_{0.1})_{0.98}(Ga_{0.8}Mg_{0.2})O_{3-delta} ELECTROLYTE ON A Sr_{0.8}La_{0.2}TIO₃ SUPPORT,” the contents of which are herein incorporated by reference in its entirety.

### STATEMENT REGARDING FEDERALLY SPONSORED□RESEARCH OR DEVELOPMENT□

This invention was made with government support under DE-FG02-05ER46255 and DE-FC52-08NA28752 awarded by the Department of Energy (subcontract letter Sep. 26, 2011 Krell Institute). The government has certain rights in the invention.

### FIELD OF INVENTION

The present disclosure relates to compositions and methods for preparing solid oxide fuel cells.

### BACKGROUND

A solid oxide fuel cell (SOFC) is a type of fuel cell characterized by the use of a solid oxide material as the electrolyte. SOFCs operate at temperatures between 700° C. to 1000° C. An oxygen ion conducting ceramic, such as yttria stabilised zirconia (YSZ), is used as an electrolyte. Oxygen from air is converted to oxygen ions at the cathode/electrolyte interface that are transported through the electrolyte to the anode, where they react with hydrogen and/or CO to produce water and/or CO₂ (FIG. 1).

Because of the high operating temperature of SOFCs, there are stringent requirements on materials of construction. In addition to excellent electrical and electrochemical properties, high chemical and thermal compatibility in the fuel cell operating environments are of utmost consideration especially in view of long term stability of over 40000-50000 h required for stationary applications. From a techno-economic consideration, the cost of materials must be low and they should be able to be fabricated into desired shapes and microstructures with ease and low cost fabrications technologies.

A single fuel cell produces just over 1 V open circuit voltage. During loading of the cell, it reduces to around 0.5-0.7 V and the current densities can vary between 200 to 1000 mA/cm² (direct current) depending on the materials of construction, cell designs and operating conditions. A number of the cells are connected in series/parallel arrangement to form a stack and to increase current/voltage output. The SOFC power plant, in addition to the fuel cell stack, consists of a number of other sub-systems which typically include a fuel processing/cleaning unit to remove impurities which may be harmful to the reformer or the fuel cell stack, an air feed unit to supply oxygen to the stack, a power management unit to condition the power (DC/AC conversion to cater for end user load requirements), a heat management unit to manage the heat from the fuel cell, and overall control and safety sub-system (FIG. 2).

SOFCs that can yield high power density at temperatures of 500-600° C., which is well below the current state-of-the-art operating range of 750-800° C., are of great interest to decrease balance of plant costs, reduce interconnector and seal materials issues, and improve long-term durability [1]. Furthermore, this same operating temperature range is desirable in solid oxide electrolysis for reducing the thermoneutral voltage and thereby allowing for improved efficiency [2] and reduced anode degradation [1]. In order to maintain low cell resistance and high power density at this reduced temperature, alternatives to the standard SOFC materials set, such as YSZ, Ni-YSZ, and (La, Sr)Mn0₃ (LSM), are needed. In particular, an alternative to the YSZ electrolyte is required to maintain low cell ohmic resistance unless a ˜1 μm thick electrolyte is utilized [3]. Furthermore, maintaining low electrode polarization resistance requires the use of highly active materials, most likely with a nanoscale structure [4,5].

Cells with thin (La, Sr)(Ga, Mg)O₃ (LSGM) electrolytes show promise for this purpose [6, 7], yielding power densities >1 W cm′ at 550° C. in one report. An unconventional strategy was used to fabricate these cells. An all-LSGM porous/dense/porous tri-layer structure was first prepared by high-temperature co-firing, followed by infiltration of active materials into the porous layers and low-temperature calcination to produce electrodes. This approach has two key advantages. First, it avoids the deleterious interaction that occurs at elevated temperatures between LSGM and Ni, the commonly used anode active material. Second, since the electrode materials are introduced after high-temperature firing, highly active nanoscale structures are achieved.

Yet LSGM is not an ideal material for the thick physical support layer of the cell for several reasons. Although details of the mechanical properties are not known, the cells are relatively fragile. In addition, the use of thick LSGM supports is likely cost-prohibitive, given that Ga is comparatively expensive [8]. Finally, an electronically conducting support, instead of ionically conducting LSGM, would be desirable to assist in current collection; the prior cells relied entirely on the impregnated Ni for current collection [5,9].

Lanthanum-doped strontium titanate, Sr_{0.8}La_{0.2}TiO₃ (SLT) is a favorable support material because of its good electronic conductivity, reasonable mechanical strength, and relatively low materials cost. SLT has previously been demonstrated as a support for cells with thin YSZ electrolytes, which were shown to be stable during many redox cycles and resistant to coking and sulfur poisoning [10]. Additionally, it has good thermal expansion match and chemical compatibility with LSGM over a wide temperature range [10-15].

### SUMMARY

In a first aspect, a low temperature operating solid oxide fuel cell (SOFC) is provided. The SOFC includes a Sr_{0.8}La_{0.2}TiO₃ (SLT) support layer, a (La_{0.9}Sr_{0.1})_{0.98}(Ga_{0.8}Mg_{0.2})O_{3-δ} (LSGM) electrolyte layer and□ a cathode layer disposed on top of said electrolyte layer.

In a second aspect, a method of making a solid oxide fuel cell is provided. The method includes several steps. The first step includes preparing an SLT powder via solid state reaction using SrCO₃, La₂O₃, and TiO₂ precursors to form a calcinated SLT product. The second step includes dispersing the calcinated SLT powder with graphite and poly(vinylbutyral) (PVB) to form a homogeneous mixture. The third step includes drying the homogenous mixture to form a dried product. The fourth step includes pressing the dried product using a die. The final step includes bisque firing the pressed product.

In a third aspect, a method of making the solid oxide fuel cell as described in first aspect is provided. The method includes several steps. The first step includes preparing an SLT powder product via solid state reaction using SrCO₃, La₂O₃, and TiO₂. The second step includes dispersing a mixture comprising the SLT powder product, graphite, a solvent carrier, a solvent and a dispersant. The third step includes forming a first slurry comprising the mixture, a binder and a plasticizer. The fourth step includes tape-casting the first slurry. The sixth step includes dispersing a mixture comprising the LSGM, graphite, a solvent carrier, a solvent and a dispersant. The seventh step includes forming a second slurry comprising the mixture, a binder and a plasticizer. The eighth step includes tape-casting the second slurry. The ninth step includes laminating the first slurry and second slurry together to produce the final ceramic□structure. The tenth step includes forming a cathode layer.

In a fourth aspect, a low temperature operating solid oxide fuel cell (SOFC) is provided. The low temperature operating solid oxide fuel cell (SOFC) includes a Sr_{0.8}La_{0.2}TiO₃ (SLT) support layer, a (La_{0.9}Sr_{0.1})_{0.98}(Ga_{0.8}Mg_{0.2})O_{3-δ} (LSGM) electrolyte layer and□a cathode layer disposed on top of said electrolyte layer. The SLT support layer and LSGM electrolyte layer include a laminated, tape-casted ceramic structure.

These and other features, objects and advantages of the present invention will become better understood from the description that follows. In the description, reference is made to the accompanying drawings, which form a part hereof and in which there is shown by way of illustration, not limitation, embodiments of the invention.

### BRIEF DESCRIPTION OF THE DRAWINGS

FIG. 1 depicts the basic operating principle of a SOFC (adapted from Badwal et al. (2014)).

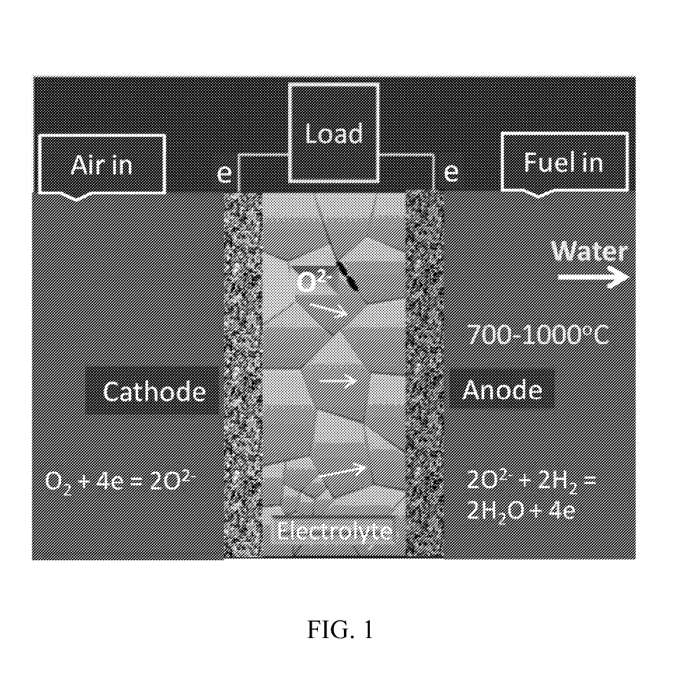

FIG. 2 depicts a typical schematic of an SOFC power plant (adapted from Badwal et al. (2014); abbreviation: NG, natural gas.

FIG. 3A depicts an exemplary fracture cross-sectional SEM image of a LSGM/porous LSGM/SLT structure prepared with an AFL colloidal containing graphite pore former after cross-firing at 1450° C. for 6 hr.

FIG. 3B depicts an exemplary fracture surface of a LSGM/SLT structure prepared with a PVB pore former in the AFL colloidal after co-firing at 1400° C. for 6 hr.

FIG. 4A depicts an exemplary cross-sectional SEM image of a cell without an AFL (Ni loading at 4.2 vol. %). Key: Color scale below image indicates the intensity of the elemental emission with pink being the highest and black being the lowest.

FIG. 4B depicts an exemplary EDS composition map showing distribution of Sr after cell fabrication and testing. Key: Color scale below image as in FIG. 4A.

FIG. 4C depicts an exemplary EDS composition map showing distribution of La after cell fabrication and testing. Key: Color scale below image as in FIG. 4A.

FIG. 4D depicts an exemplary EDS composition map showing distribution of Ti after cell fabrication and testing. Key: Color scale below image as in FIG. 4A.

FIG. 4E depicts an exemplary EDS composition map showing distribution of Ni after cell fabrication and testing. Key: Color scale below image as in FIG. 4A.

FIG. 5A depicts an exemplary cross-sectional SEM image of a cell with a LSGM/40 wt. % PVB AFL (Ni loading at 4.2 vol. %). Key: Color scale below image indicates the intensity of the elemental emission with pink being the highest and black being the lowest.

FIG. 5B depicts an exemplary EDS composition map showing distribution of Sr after cell fabrication and testing. Key: Color scale below image as in FIG. 5A.

FIG. 5C depicts an exemplary EDS composition map showing distribution of La after cell fabrication and testing. Key: Color scale below image as in FIG. 5A.

FIG. 5D depicts an exemplary EDS composition map showing distribution of Ti after cell fabrication and testing. Key: Color scale below image as in FIG. 5A.

FIG. 5E depicts an exemplary EDS composition map showing distribution of Ni after cell fabrication and testing. Key: Color scale below image as in FIG. 5A.

FIG. 6A depicts an exemplary fracture cross-sectional SEM image of a cell without an AFL The boxed regions indicated by “B,” “C,” and “D” are sampled EDS spectra presented in FIGS. 6B-D.

FIG. 6B depicts an exemplary EDS spectrum from the LSGM electrolyte. The arrows indicate where the Ti peaks would appear in the spectrum for the electrolyte. Osmium peaks are present because Os was used to coat the samples for SEM.

FIG. 6C depicts an exemplary EDS spectrum from the LSCF/GDC cathode. Osmium peaks are present because Os was used to coat the samples for SEM.

FIG. 6D depicts an exemplary EDS spectrum from the LSCF current collector. Osmium peaks are present because Os was used to coat the samples for SEM.

FIG. 7 depicts Ni nanoparticles in the LSGM/40 wt. % PVB AFL of a cell tested at 650° C. and below (Ni loading at 4.2 vol.%) (panel (i). The orange square of panel (i) indicates the magnified portion of the image of panel (i) (presented in panel (ii)).

FIG. 8 depicts Ni nanoparticles in the LSGM/40 wt. % PVB AFL of a cell tested above 700 C (Ni loading at 4.2 vol.%) (panel (i), where the larger area are believed to be Ni that had coarsened as a result of heating above 700° C. before electrochemical testing. NI EDS map of a smaller area in the LSGM/40 wt. % PVB AFL showing Ni nanoparticles (Ni loading at 4.2 vol.%) (panel (ii).

FIG. 9A depicts an exemplary current-voltage characterization of a fuel cell without an AFL and Ni loading of 4.2 vol.%.

FIG. 9B depicts an exemplary current-voltage characterization of a fuel cell with a LSGM/40 wt. % PVB AFL and Ni loading of 4.2 vol.%.

FIG. 10A depicts an exemplary Nyquist plot of the EIS data for the cell measured at 650 C fueled by H₂ under different partial pressures. The water vapor partial pressure is constant at 0.03 atm. The scattered pointes are raw data, and the solid lines are the fitting results.

FIG. 10B depicts an exemplary Bode plot of the EIS data for the cell measured at 650 C fueled by H₂ under different partial pressures. The water vapor partial pressure is constant at 0.03 atm. The scattered pointes are raw data, and the solid lines are the fitting results.

FIG. 11 depicts an exemplary Ohmic resistance and anode resistance vs. different H₂ partial pressures obtained in FIG. 10.

FIG. 12 illustrates exemplary processing scheme for preparing tape-casted SOFC with thin La_{0.8}Sr_{0.2}Ga_{0.8}Mg_{0.2}O_{3-δ}electrolyte and nano-scaled anode on Sr_{0.8}La_{0.2}TiO_{3α} support, wherein processes for preparing an SLT support having SLT with 30 wt. % graphite (panel (i)), an anode functional layer LSGM with 30 wt. % graphite (panel (ii)), and LSGM electrolyte are presented.

FIG. 13 depicts an exemplary cross-sectional SEM for the cell with 30 wt. % graphite in the anode functional layer fabricated by tape casting after testing.

FIG. 14 depicts an exemplary plot of the maximum power density measured at different temperatures for cells with different graphite amount in anode functional layer and Ni loading amounts.

FIG. 15 depicts an exemplary plot of voltage and power density versus current density measured in flow air with 200 sccm and 100 sccm humidified H₂ at different temperatures, for the fuel cell with 30 wt. % graphite and 32.5 wt. % NiO in AFL.

FIG. 16 depicts exemplary Nyquist plots of impedance data taken at different temperatures for the optimized cell with 30 wt. % graphite and 32.5 wt. % NiO in AFL.

FIG. 17 depicts an exemplary plot of voltage versus current density for the optimized button cells with 50 vol.% H₂/50 vol.% H₂O under electrolysis at different temperatures

FIG. 18 depicts exemplary Nyquist plots of impedance data taken at different temperatures for the optimized cell under electrolysis with 50 vol.% H₂/50 vol.% H₂O composition.

FIG. 19 depicts exemplary plots of IV and IP curves for a cell operated with a 50:50 mixture of methane and steam. Temperatures shown are corrected using the ohmic resistances from EIS measurements.

FIG. 20 depicts exemplary plots of IV and IP curves for a cell operated with a 40:60 mixture of methane and steam. Temperatures shown are corrected using the ohmic resistances from EIS measurements.

FIG. 21 depicts an exemplary plot of voltage versus time at constant current density.

FIG. 22 depicts exemplary plots of voltage versus current density for the cell fuelled with different compositions at different temperatures.

### DETAILED DESCRIPTION

The present disclosure provides details of the discovery of Sr_{0.8}La_{0.2}Ti0₃ (SLT)-supported solid oxide fuel cells with a thin (La_{0.9}Sr_{0.1})_{0.98}Ga_{0.8}Mg_{0.2}O_{3-δ} (LSGM) electrolyte and porous LSGM anode functional layer (AFL). Optimized processing for the SLT support bisque firing, LSGM electrolyte layer co-firing, and LSGM AFL colloidal composition is presented. Cells without a functional layer yielded a power density of 228 mW cm⁻² at 650° C., while cells with a porous LSGM functional layer yielded a power density of 434 mW cm⁻³ at 650° C. Cells with an AFL yielded a higher open circuit voltage, possibly due to reduced Ti diffusion into the electrolyte. Infiltration produced Ni nanoparticles within the support and AFL, which proved beneficial for the electrochemical activity of the anode. Power densities increased with increasing Ni loadings, reaching 514 mW cm⁻² at 650° C. for 5.1 vol.% Ni loading. These and other aspects are described below.

### TERMINOLOGY AND DEFINITIONS

The terminology used herein is for the purpose of describing particular embodiments only, and is not intended to be limiting. With respect to the use of substantially, any plural and/or singular terms herein, those having skill in the art can translate from the plural as is appropriate to the context and/or application. The various singular/plural permutations may be expressly set forth herein for the sake of clarity.

Terms used herein are intended as “open” terms (e.g., the term “including” should be interpreted as “including but not limited to,” the term “having” should be interpreted as “having at least,” the term “includes” should be interpreted as “includes but is not limited to,” etc.).

The phrase “such as” should be interpreted as “for example, including.”

Furthermore, in those instances where a convention analogous to “at least one of A, B and C, etc.” is used, in general such a construction is intended in the sense of one having ordinary skill in the art would understand the convention (e.g., “a system having at least one of A, B and C” would include but not be limited to systems that have A alone, B alone, C alone, A and B together, A and C together, B and C together, and/or A, B, and C together.). It will be further understood by those within the art that virtually any disjunctive word and/or phrase presenting two or more alternative terms, whether in the description or figures, should be understood to contemplate the possibilities of including one of the terms, either of the terms, or both terms. For example, the phrase “A or B” will be understood to include the possibilities of “A” or ‘B or “A and B.”

All language such as “up to,” “at least,” “greater than,” “less than,” and the like, include the number recited and refer to ranges which can subsequently be broken down into subranges as discussed above.

A range includes each individual member. Thus, for example, a group having 1-3 members refers to groups having 1, 2, or 3 members. Similarly, a group having 6 members refers to groups having 1, 2, 3, 4, or 6 members, and so forth.

The modal verb “may” refers to the preferred use or selection of one or more options or choices among the several described embodiments or features contained within the same. Where no options or choices are disclosed regarding a particular embodiment or feature contained in the same, the modal verb “may” refers to an affirmative act regarding how to make or use and aspect of a described embodiment or feature contained in the same, or a definitive decision to use a specific skill regarding a described embodiment or feature contained in the same. In this latter context, the modal verb “may” has the same meaning and connotation as the auxiliary verb “can.”

Processing Optimization for Sr_{0.8}La_{0.2}TiO₃ (SLT)-Supported Solid Oxide Fuel Cells with a Thin (La_{0.9}Sr_{0.1})_{0.96}Ga_{0.8}Mg_{0.2}O_{3-δ} (LSGM) Electrolyte and Porous LSGM Anode Functional Layer (AFL).

Powder Calcination and Support Bisque Firing

The SLT powder was calcined for 4 h at two different temperatures, 950° C. and 1,200° C. The lower calcination temperature (950° C.) yielded a finer powder that shrank more during bisque firing and was well matched to the LSGM shrinkage during co-firing. This calcination time and temperature is consistent with previous work on SLT anode supported cells with YSZ electrolytes [16]. The coarser 1,200° C.-calcined powder generally had less shrinkage than the LSGM, usually resulting in considerable curvature after co-firing with LSGM. All of the results described below were for SLT powder calcined at 950° C.

The SLT bisque firing temperature was optimized to yield sufficient strength for handling/processing and to match the shrinkages of the SLT and LSGM layers during co-firing. Bisque firing at 1,350° C., even at short dwell times (˜4 h), yielded considerable SLT shrinkage, leaving too little shrinkage to match the dimensional change of the LSGM during co-firing. Pellets bisque fired at 1,200° C. were not mechanically robust enough for subsequent processing, even at longer dwell times (˜8 h), and colloidal solutions often soaked through the pellet when deposited. The optimal firing condition, which yielded nearly planar SLT/LSGM pellets after co-firing, was found to be 1,320° C. with a 4 h dwell time.

Colloidal Deposition

Colloidal deposition of the electrolyte layer directly on the SLT support (i.e., without a LSGM AFL) generally yielded adherent and crack-free layers after drying. However, LSGM AFL and electrolyte layer colloidal deposition required optimization in order to produce uniform crack-free layers. In some cases, the layers exhibited cracking or delamination during drying, often after the second application of pore colloidal solution. In other cases, the layers dried satisfactorily only to delaminate or crack during the high-temperature co-firing, as discussed further below.

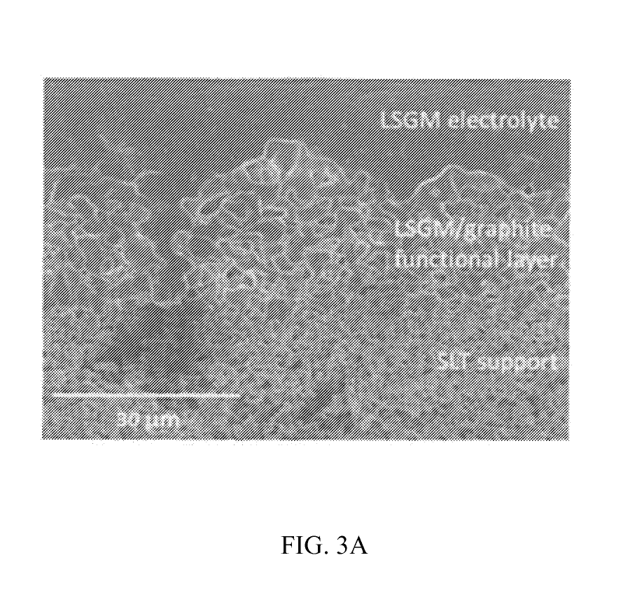

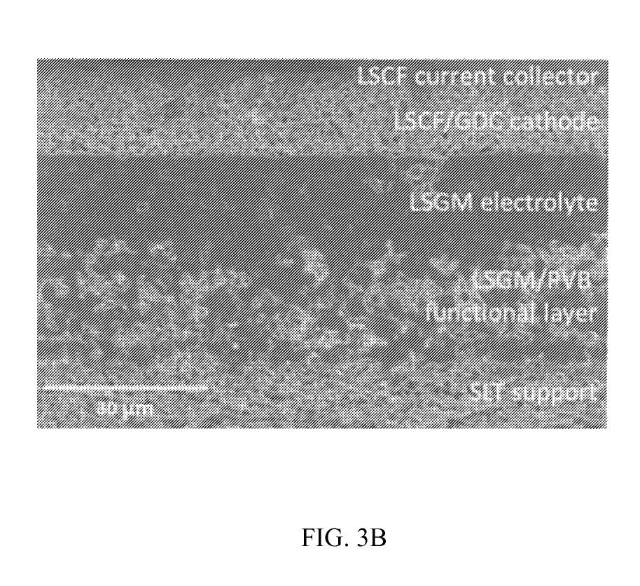

In initial tests, LSGM colloidals with different pore formers were attempted. Some, but not all, functional layers deposited from PMMA-containing colloidals delaminated from the pellet during drying. Colloidals with tapioca starch adhered to the pellet but yielded non-uniform porosity. Graphite pore former yielded large, uniformly distributed pores but allowed seepage of the subsequently-deposited electrolyte colloidal into the functional layer in some areas, as shown in the denser region to the left in FIG. 3A. The most successful measure was to increase the amount of PVB, normally present at ˜3 wt. % as a binder in the colloidal solutions, to 30-40 wt. %, resulting in adherent AFL layers with small pores, as shown in FIG. 3B. However, when the electrolyte layer was deposited onto the dried, green AFL, the layers often flaked off the pellet. This delamination was presumably a result of the larger drying stress associated with the thicker combined AFL/electrolyte layers. In order to avoid this problem and produce adherent and crack-free LSGM layers, the AFLs were fired at 1,000° C. for 1 h prior to electrolyte deposition. Successful cells with AFLs were made using this procedure with the PVB pore former colloidal.

LSGM/SLT Co-Firing

For cells prepared without a LSGM AFL, it was relatively straightforward to obtain dense and crack-free LSGM electrolyte layers by co-firing at 1,450° C. for 6 h. On the other hand, cracking was often observed after firing in the structures that included LSGM AFLs. Co-firing with a reduced hold temperature of 1,400° C. for 4 h using a ramp rate of 3° C. min⁻¹ to 600° C. followed by a 5° C. min⁻¹ ramp to 1,400° C. yielded flat pellets with entirely crack-free LSGM layers for the cells with AFL.

Structural and Chemical Characterization

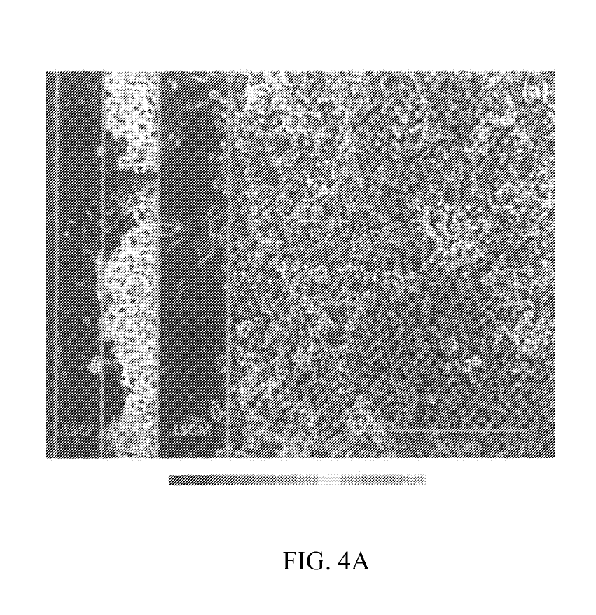

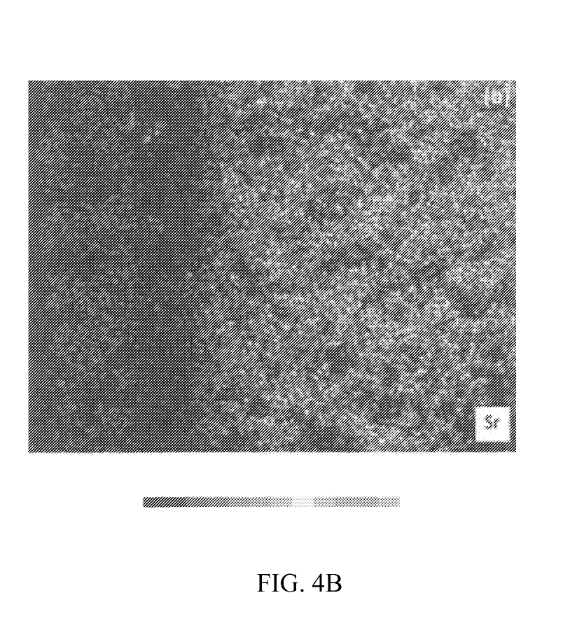

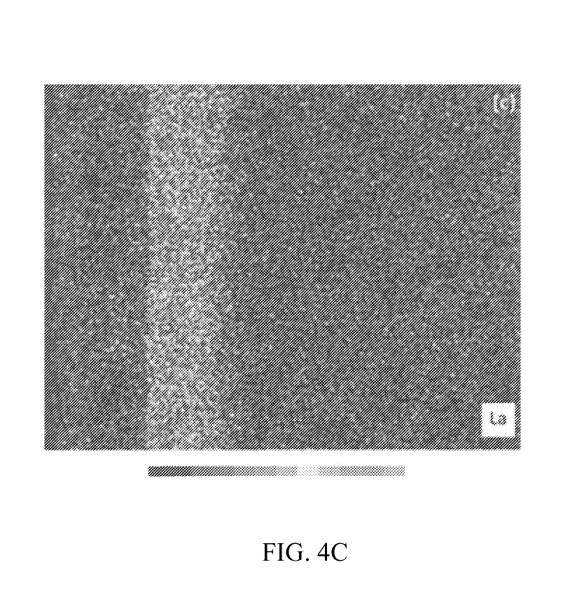

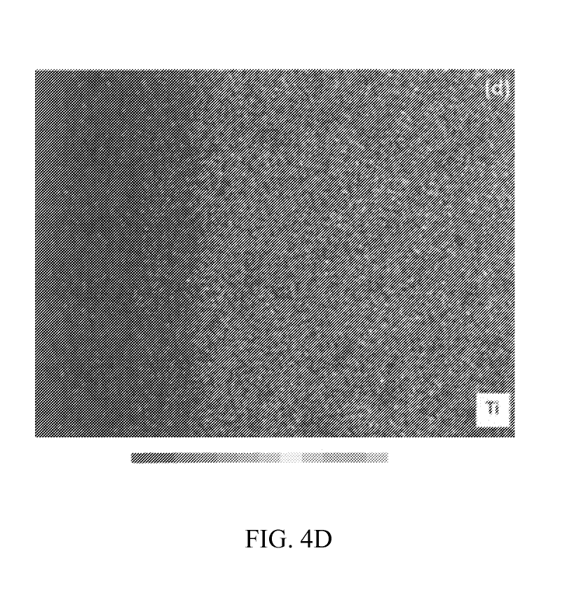

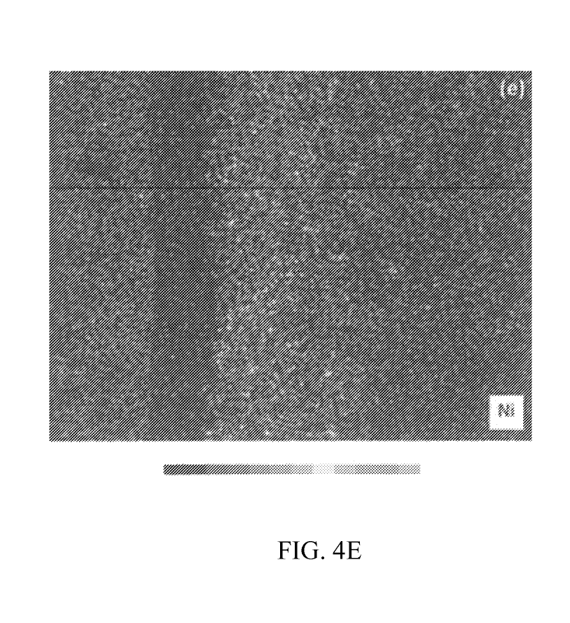

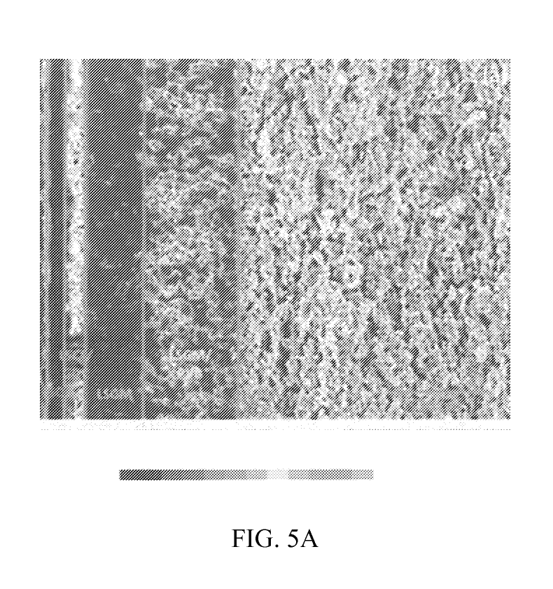

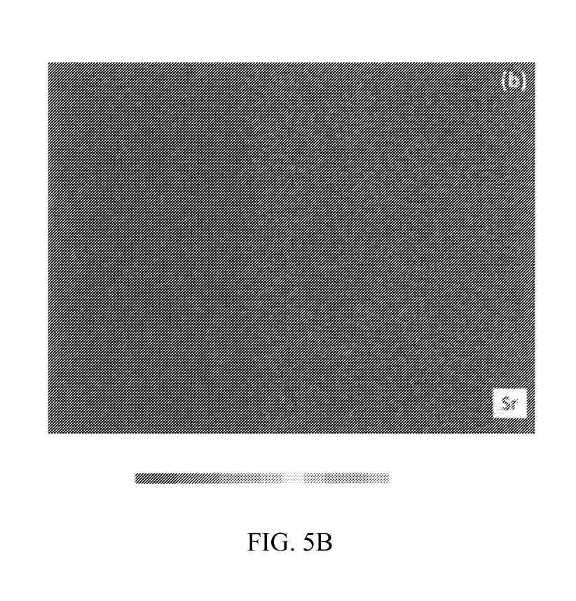

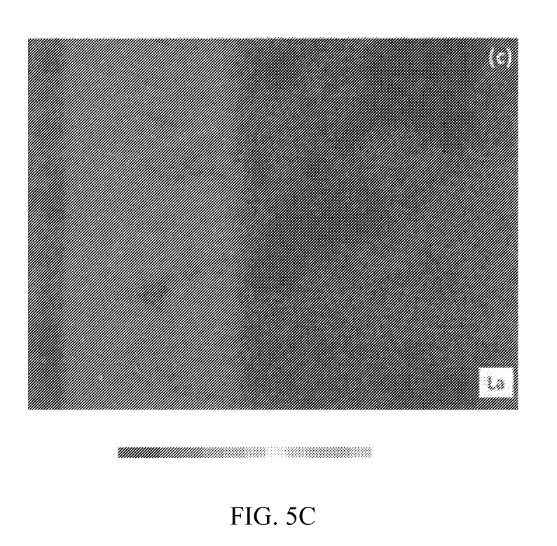

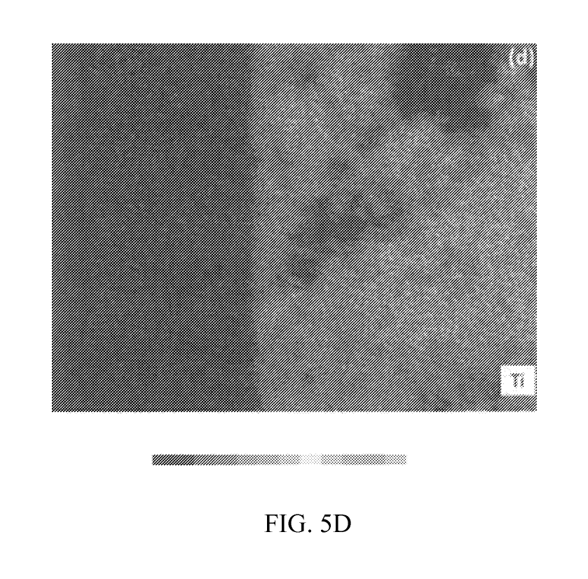

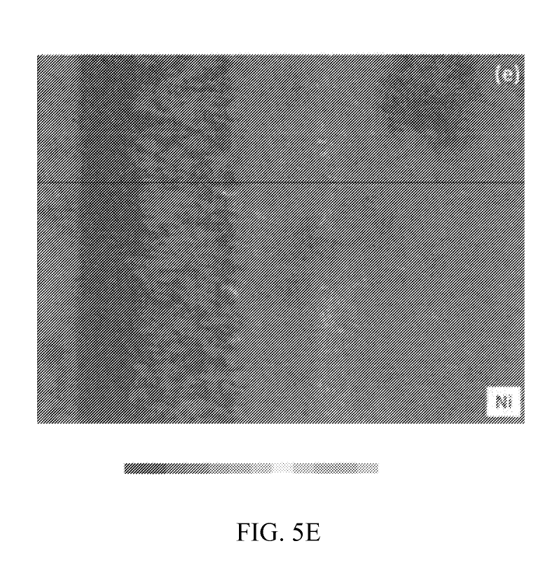

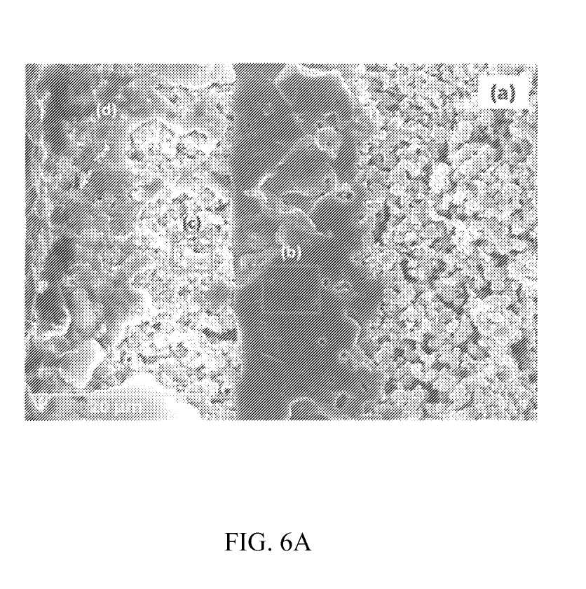

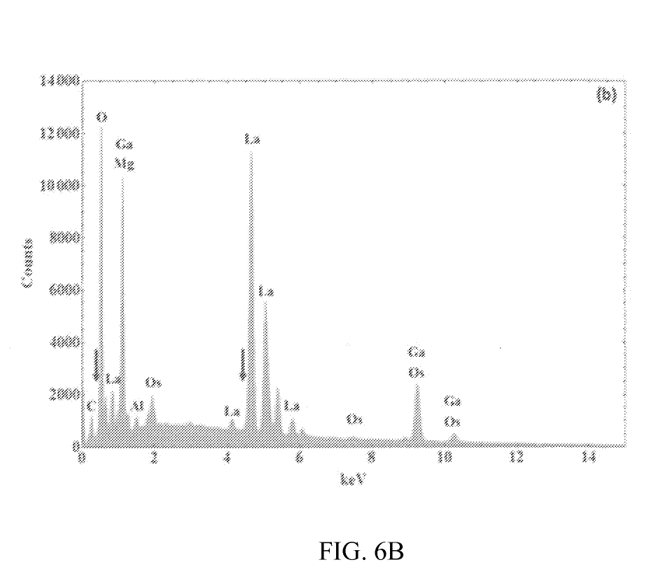

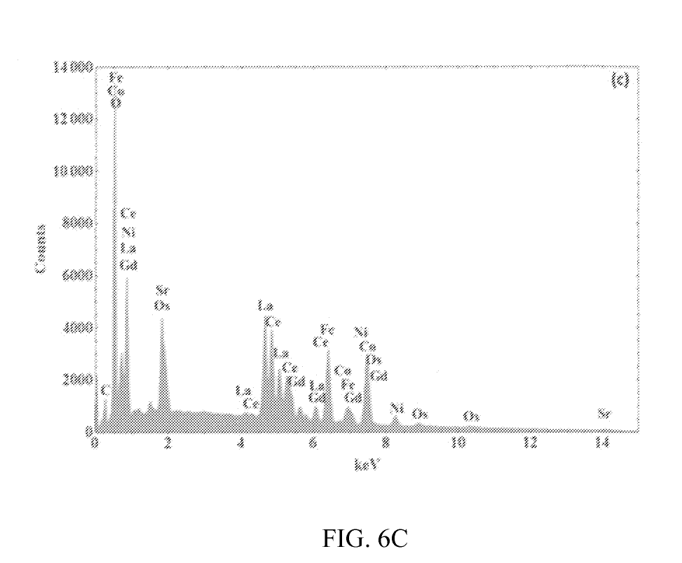

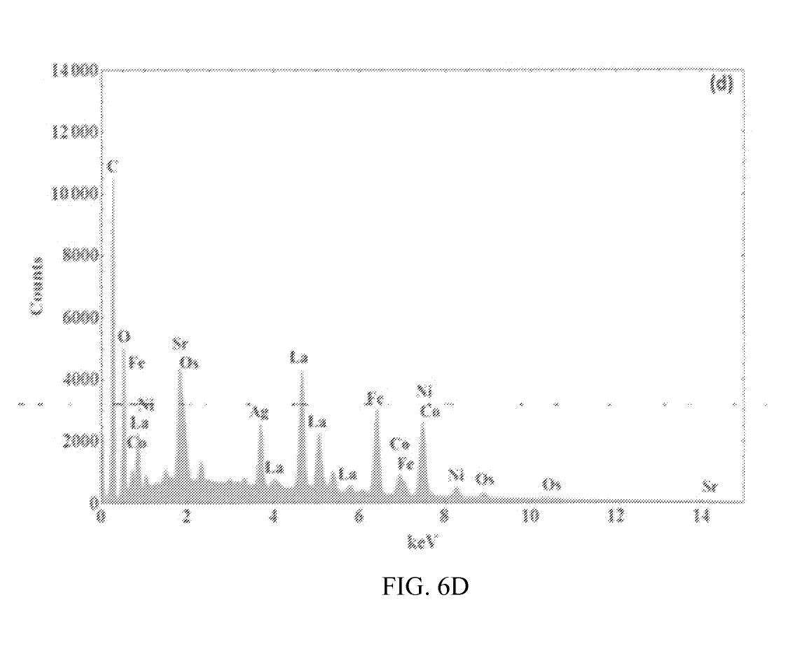

FIG. 4A shows results of SEM-EDS compositional mapping of a SOFC prepared without a porous LSGM layer. FIG. 4B shows the SEM-EDS of a SOFC with a LSGM/40 wt. % PVB AFL made using the optimized procedure described above. In both cases, the Sr intensity was highest in the SLT layer and lower in the cathode and electrolyte, in agreement with their compositions. The La intensity also agreed qualitatively with the compositions of each layer with the highest La concentration observed in the electrolyte layer. There was no evidence of re-distribution of these elements, indicating that the La content in the SLT was sufficient to prevent significant loss of La from LSGM (FIG. 4C), which has proved problematic previously when LSGM was used with other materials [3, 19, 20]. Ti was present mainly in the SLT layer in both cases. In the cell without an AFL, a weak Ti intensity appeared in the electrolyte in the composition map in FIG. 4D. To test if this truly indicated that Ti was present, the EDS spectrum was examined. FIG. 5A shows the location where the EDS spectrum was recorded, indicated by the blue square in the LSGM electrolyte layer. The spectrum (FIG. 6B) showed no evidence of Ti peaks; rather, the apparent Ti intensity, evaluated at ˜4.5 and ˜0.45 keV, is an artifact with slight intensity coming from nearby La and O peaks. Thus, despite co-firing at 1,400° C. with SLT in direct contact with the LSGM electrolyte, the Ti content in the LSGM was ≦1 at.%, the detection limit of EDS. In the cell with an AFL (FIG. 5D), the Ti intensity abruptly dropped at the SLT-AFL interface, with little or no Ti intensity in the AFL.

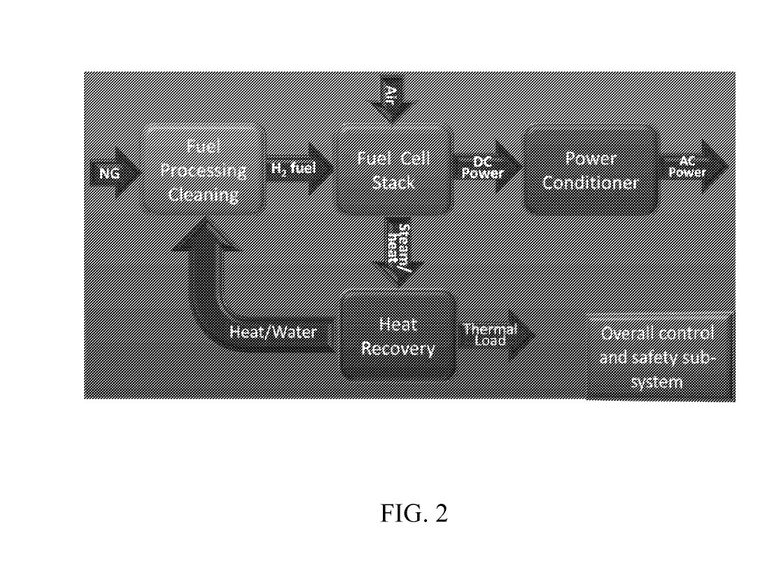

The Ni composition map in FIG. 4E shows that Ni was present throughout the support, with a greater Ni signal intensity near the electrolyte/support interface. In FIG. 5E, a Ni signal is present in the SLT support and LSGM AFL, although the Ni content in the AFL appears to be lower than that in the SLT support. That is, the infiltration procedure was effective for getting Ni through the thick SLT support to the electrolyte, where it is needed for anode electrochemistry. The higher Ni content near the electrolyte in FIG. 2e might be explained by an enrichment of infiltrate solution with nickel nitrate at the end of drying, which presumably occurs furthest from the open surface of the SLT. The slightly lower Ni content in the AFL seen in FIG. 3e might result if the pore fraction in the AFL were smaller than in the support such that it holds less infiltrate liquid and hence less Ni.

The apparent Ni intensity in the LSCF/GDC porous cathode layer and LSCF current collector layer was also an artifact of peak overlap in the EDS spectra. This overlap can be seen in FIG. 6, which shows EDS spectra taken in the LSCF/GDC layer (red square in FIG. 6A) and LSCF layer (green square in FIG. 6A). In the LSCF/GDC layer spectrum shown in FIG. 6C, the peaks for Ce, Ni, Co, La, and Gd overlap at ˜0.9 keV. At the same energy, peak overlap for Co, Ni, and La is observed in the LSCF spectrum (FIG. 6D). Similar overlap of Ni and Co peaks is observed at 7.5 keV on both spectra. Osmium peaks are present in all spectra because Os was used to coat the samples for SEM.

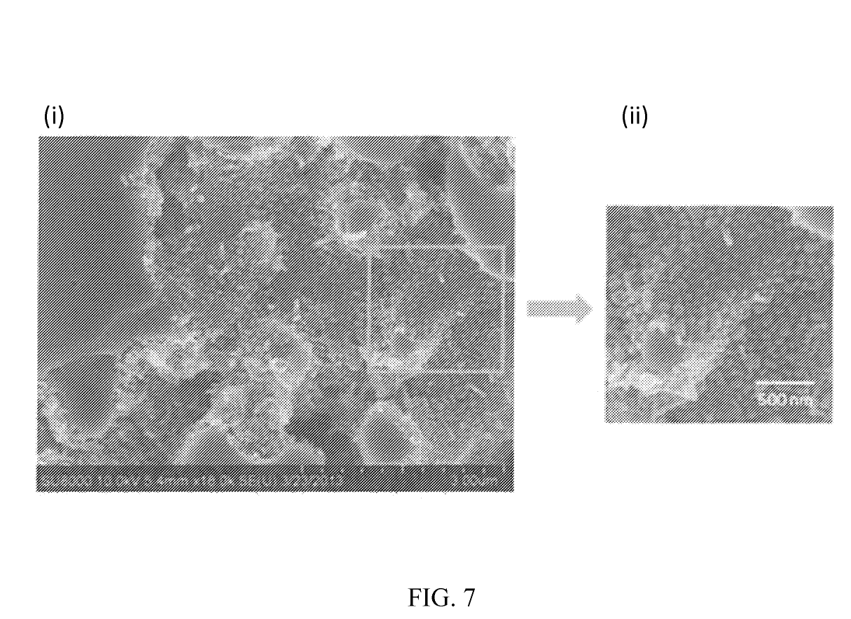

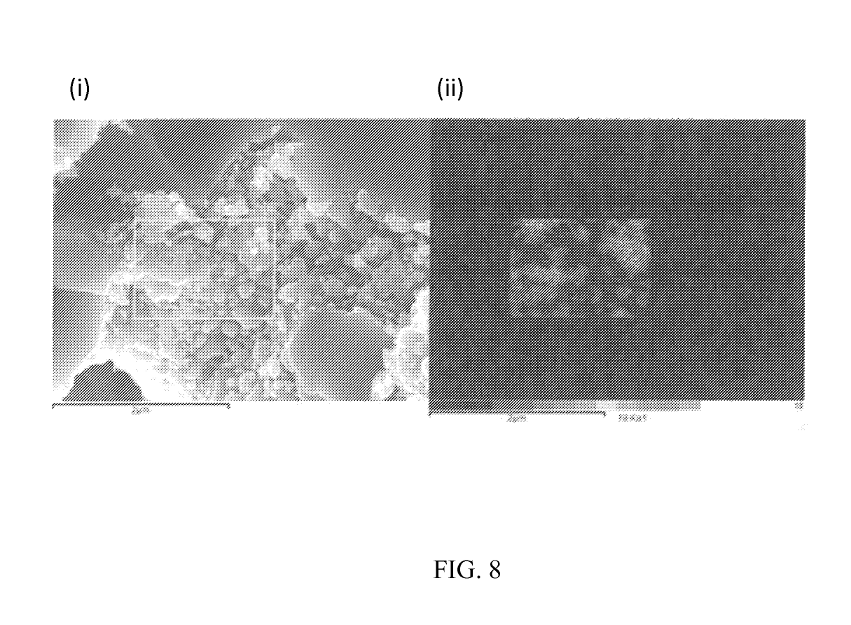

Higher-magnification SEM imaging of the AFL was performed to better observe the pore structure and the infiltrated Ni. FIG. 7 is an image of the surface produced by fracturing a cell after electrochemical testing, which shows a portion of the internal pore structure decorated with well-connected Ni nanoparticles. The pore features generally appear to be on the micron scale with some smaller features as shown in the magnified portion of the image (orange square). Although the images show minimal contrast between Ni and LSGM, Ni can often be identified by its small feature size in contrast to the LSGM scaffold, as in prior work [6, 7]. EDS mapping was performed in order to verify the identity of the particles. An SEM image of a Ni-infiltrated functional layer is shown in FIG. 8A, along with the corresponding Ni EDS map in FIG. 8B. Note that this cell, which had a coarser Ni structure than that shown in FIG. 5 because of extended cell testing above 700° C., was chosen in order to help overcome the limited spatial resolution of EDS. The Ni EDS signal from the nanoparticles confirms that they are Ni. Comparison of FIGS. 7 and 8 provides evidence of coarsening and/or agglomeration of Ni particles at or above 700° C., perhaps accompanied by an increasing number of isolated Ni particles. Clearly, these infiltrated Ni anodes are not suitable for cells operating above 650° C.

Electrochemical Testing

Current-Voltage Testing

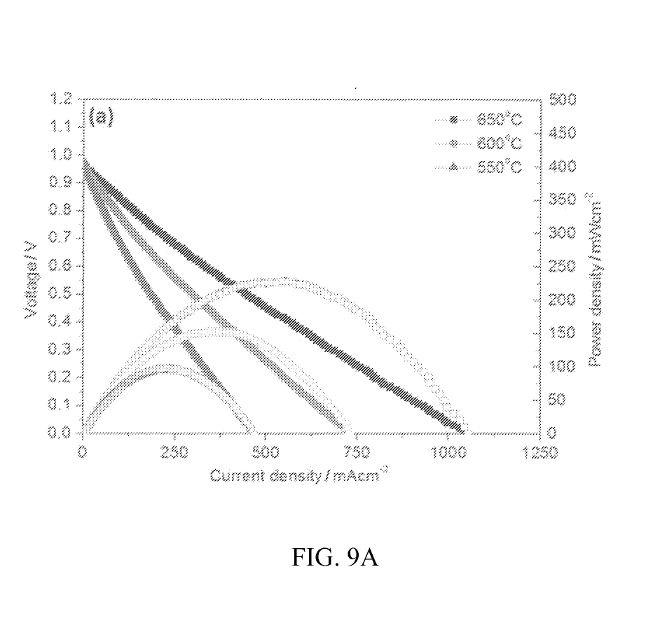

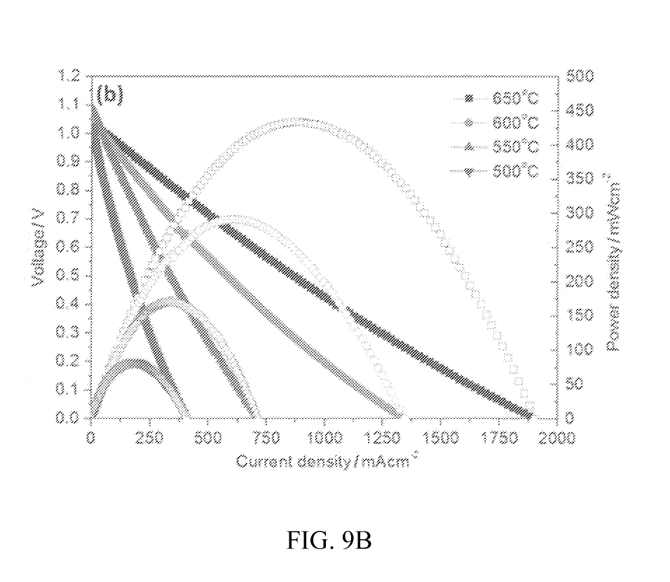

FIG. 9A shows the current-voltage characteristics of a cell without a functional layer and a Ni loading of 4.2 vol.%. The open circuit voltages (OCVs) are ˜0.97 V in the measured temperature range of 550-650° C., which is substantially less than the predicted Nernst potential of 1.15 V at 650° C. in ambient air and 97% H₂/3% H₂0 fuel. The current-voltage curves showed positive curvature suggesting that activation polarization was a significant contributor to the cell resistance. Maximum power density increased from ˜100 to 220 mW cm⁻² with increasing temperature from 550 to 650° C.

FIG. 9B presents the current-voltage characteristics of a cell with a LSGM/40 wt. % PVB AFL that was otherwise prepared identically to that shown in FIG. 9A. The fuel cell performance was much improved by the AFL. Under the same test conditions, OCVs increased to ˜1.05 to 1.1 V, within ˜50 mV of the Nernst potential, a reasonable result for this test setup which typically yields slightly below-theoretical OCVs due to gas-seal leakage [18]. Maximum power density was higher with the AFL, increasing from 170 to 430 mW cm⁻² from 550 to 650° C., respectively, although the positive curvature of the current-voltage curves remained.

The reason for the low OCV of the cell without an AFL is not known. One possible explanation is the presence of Ti in the electrolyte of the cell, although it is not known whether Ti causes electronic conductivity in LSGM. It seems plausible that there was more Ti interdiffusion into the electrolyte in the cell with no AFL where the SLT support directly contacts the electrolyte; however, any Ti impurity is below the EDS detection limit of ˜1 at.%, as discussed above. The higher power density of the cell with an AFL can be attributed to the activity of Ni-LSGM-gas triple phase boundaries (TPBs), which extended a substantial distance into the AFL, owing to the high ionic conductivity of LSGM. In the cell with no AFL, only TPBs at or near the LSGM electrolyte can contribute to the hydrogen oxidation reaction, yielding a high anode polarization resistance, since SLT has poor ionic conductivity.

Slightly higher power density (up to 510 Mw cm⁻² at 650° C.) was obtained in a cell with an AFL by increasing the Ni loading to 5.1 vol.%. The increased Ni loading presumably increases the power density by increasing the Ni-LSGM TPB length and improving the electrical continuity with the Ni phase, as discussed previously [6].

Impedance Measurements

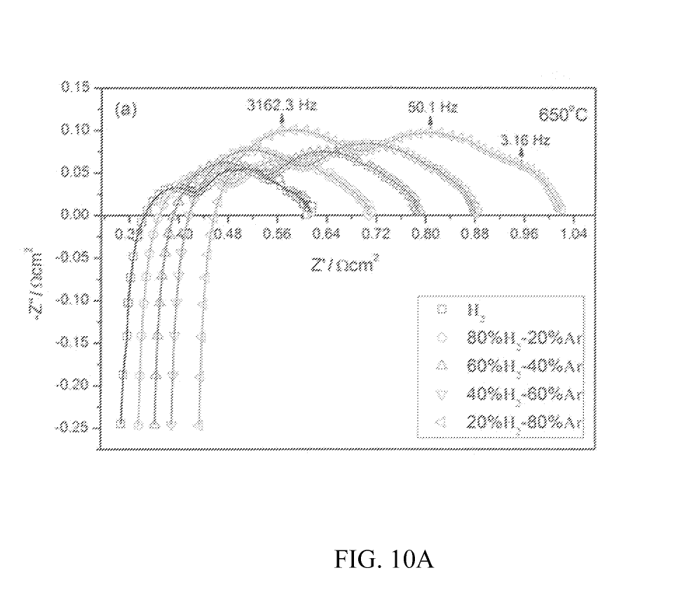

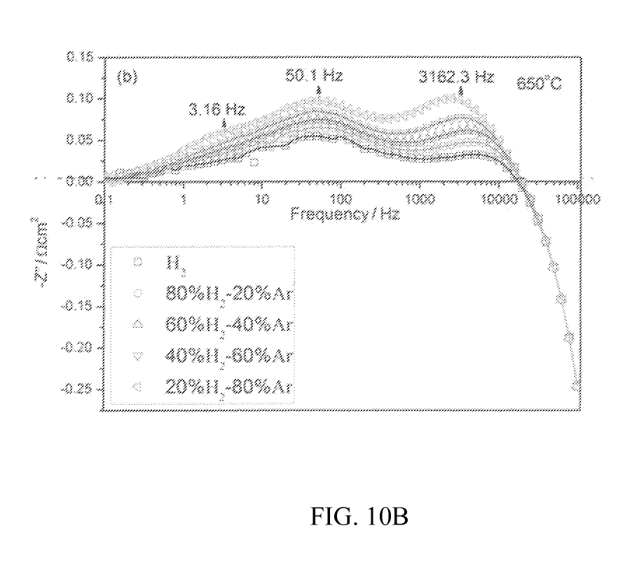

FIG. 10 shows Nyquist (FIG. 10A) and Bode (FIG. 10B) plots of impedance spectra measured under different H₂ partial pressures P_{H2}, at 650° C. from a cell with an AFL and a Ni loading of 4.2 vol.%. The H₂0 partial pressure was constant at 0.03 atm with the balance being Ar gas. The spectra, showing three broad peaks centered at ˜3, ˜50, and ˜8,000 Hz, are modeled by three Cole elements in series with an inductor and resistor, LR(RQ) (RQ) (RQ) with Q=Yₒ(jΩ)ⁿ. The medium-frequency element was assigned to the cathode based on a comparison with symmetrical cathode cell tests. Indeed, the impedance element used to fit the cathode symmetric cell, with a resistance of 0.2 Ωcm² at 650° C., was also used directly in the fit of the full cell. The low-frequency response increased with decreasing P_{H2}, and is probably related to a gas diffusion or adsorption process in the anode. The high-frequency response increased with decreasing P_{H2}, it is associated with the anode. The medium frequency response also appeared to increase, but this effect is mainly due to the increases in the broad surrounding peaks.

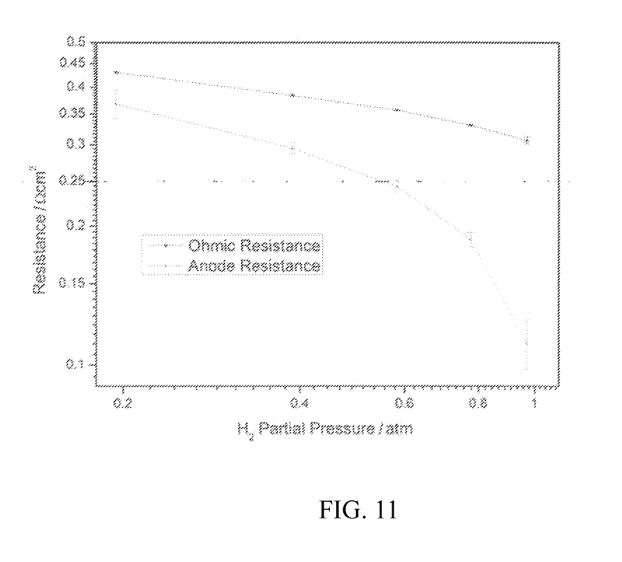

FIG. 11 is a plot of the ohmic and total anode resistances obtained from the fits at varying P_{H2}. Overall, the infiltrated Ni-LSGM AFL polarization resistance is small (i.e., 0.11 Ωcm² for P_{H2}=0.97 atm) relative to the ohmic and cathode resistance. The ohmic resistance is only partly due to the ˜18 μm thick LSGM electrolyte with a resistance of ˜0.07 Ωcm² at 650° C. The remainder, ˜0.24 Ωcm² at 650° C., can be attributed to the 800 μm-thick SLT support. Although resistivity values for this SLT composition under these conditions are not available, the calculated support resistance contribution is reasonably consistent with that observed previously for SLT-supported YSZ-electrolyte cells [15]. The increase of ohmic resistance with decreasing P_{H2} is explained by an increased SLT resistivity, expected since it is an n-type conductor [21]. The electrolyte resistivity does not change with P_{H2}.

SLT supported cells with thin LSGM electrolytes were successfully fabricated and tested. Lower SLT powder calcination and support bisque firing temperatures yielded sufficiently strong supports and compatible shrinkages with the LSGM layers during co-firing. Cells made with a LSGM AFL and using PVB as the pore former had a very low anode polarization resistance due to a high density of Ni-LSGM TPBs within the AFL. Cells without an AFL had higher resistance due mainly to a lower activity of Ni-SLT TPBs. Cells with an AFL also yielded higher open circuit voltage, perhaps by reducing diffusion of Ti into the electrolyte during high-temperature co-firing. Cells with higher Ni loading exhibited higher power density than cells with lower Ni loading. Electrochemical impedance spectroscopy results indicated that the cell performance was determined mainly by the cathode resistance and ohmic resistance. Ohmic resistance, attributed mainly to the SLT support, increased with decreasing P_{H2}. The anode polarization resistance was relatively small but increased with decreasing H₂ partial pressure. The present cells can be improved by utilizing a better cathode, reducing LSGM electrolyte thickness, and decreasing the SLT support resistance. The latter component can be improved somewhat by reducing the support thickness, but more improvement can be expected by increasing the Ni loading such that a connected Ni network provides an alternative low resistance pathway for electronic conduction.

Fabrication and Optimization of a Tape-Casted SOFC with Thin La_{0.8}Sr_{0.2}Ga_{0.8}Mg_{0.2}P_{3-δ}Electrolyte and Nano-Scaled Anode on Sr_{0.8}La_{0.2}TiO_{3-α} Support.

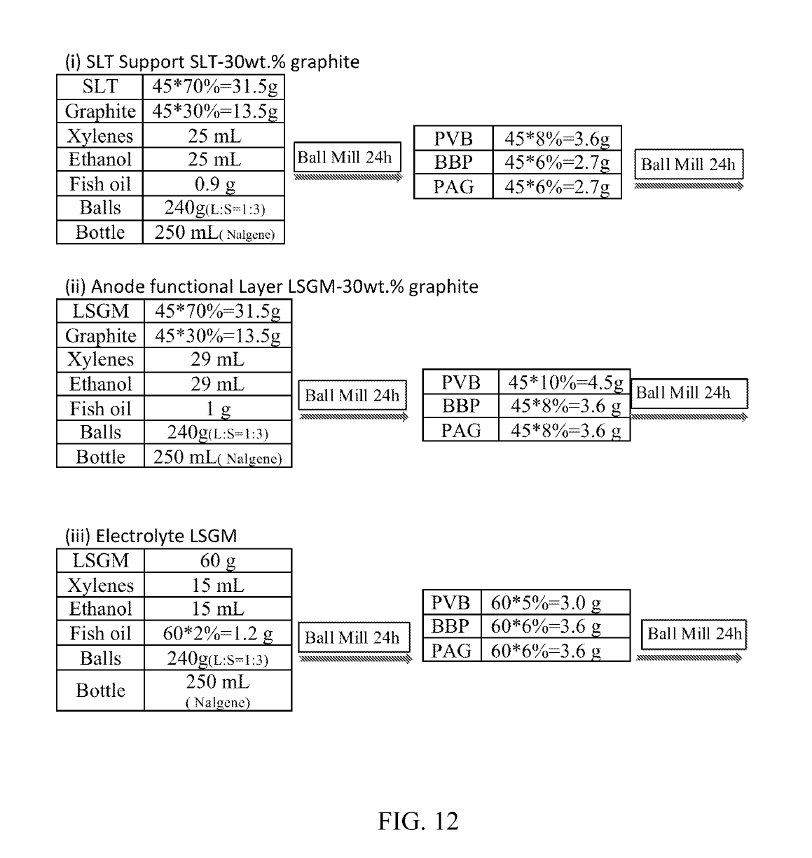

A tape casting technology to fabricate high performance SOFC was developed and the cell fabrication processes were optimized. Example 4 and FIG. 12 illustrates some exemplary processing schemes for SLT, anode functional layer (ALF) LSGM and LSGM electrolyte formulations. The SLT support layer and AFL LSGM were fabricated with graphite in the range from about 20 wt. % to about 40 wt. % graphite. Preferred compositions of graphite in the SLT support layer and the AFL LSGM include graphite from about 30 wt. %. The respective SLT support layer and AFL LSGM are mixed with additional materials, such as xylenes, ethanol and fish oil. Mixing can be accomplished in a variety of ways. Ball milling the mixture with balls in a chemically inert container (for example, a polypropylene bottle, such as Nalge bottle) is carried out typically for 24 hours. After the graphite mixture is ball milled, polyvinyl butyral (PVB), polyalkylene glycol (PAG), and benzyl butyl phthalate (BBP) are added to the respective SLT support layer and AFL LSGM materials and the resultant mixtures are mixed further, preferably in a similar manner and time.

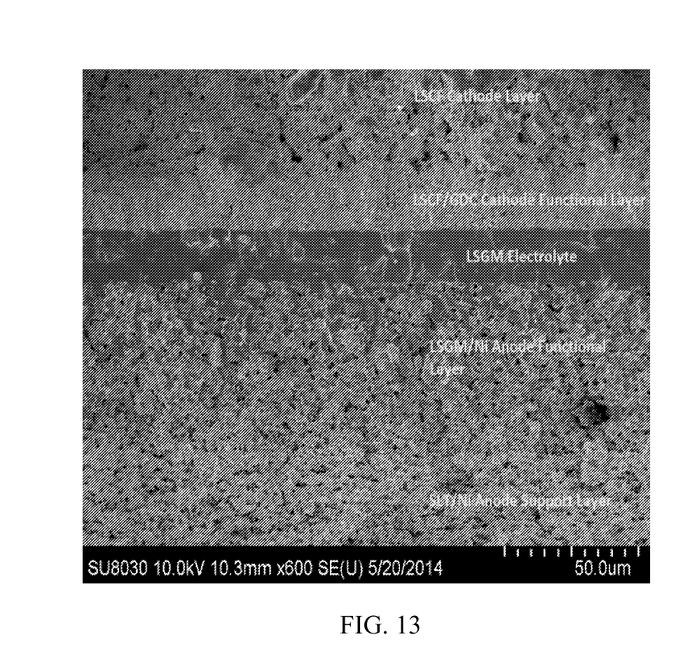

FIG. 13 shows an exemplary cell microstructure after testing in H₂. The SLT-30 wt. % graphite support is about 600-micron thickness. The anode functional layer is about 50 microns and contains about 30 wt. % graphite. The NiO loading amount is about 32.5 wt. %. The cathode thickness of LSCF-GDC/LSCF is about 40 microns.

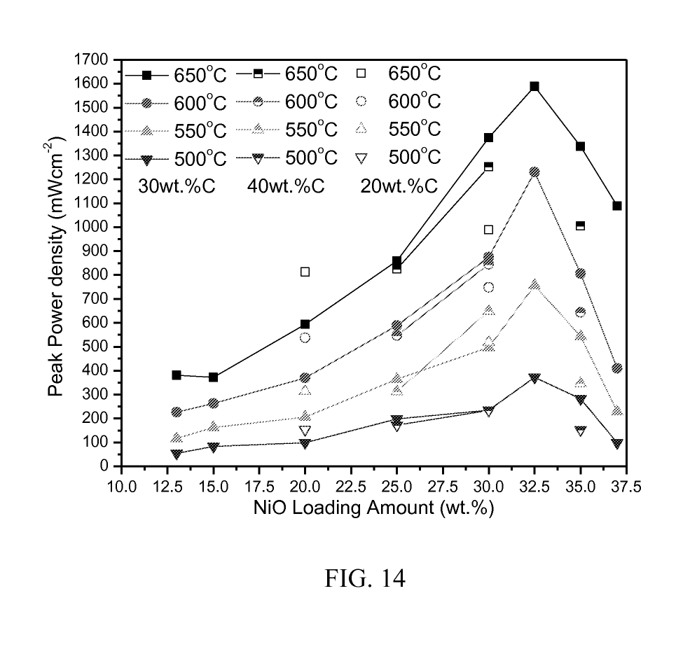

FIG. 14 shows exemplary plots the variation of the maximum power density, measured at different operating temperatures, with different AFLs and different NiO loading amounts. The best cell performance yields when the AFL contains 30 wt. % graphite. Power density values increased continuously with increasing NiO loading amount to 32.5 wt. %. The highest power density yields when the NiO loading amount is 32.5 wt. %. Further loading in NiO will decrease the cell performance.

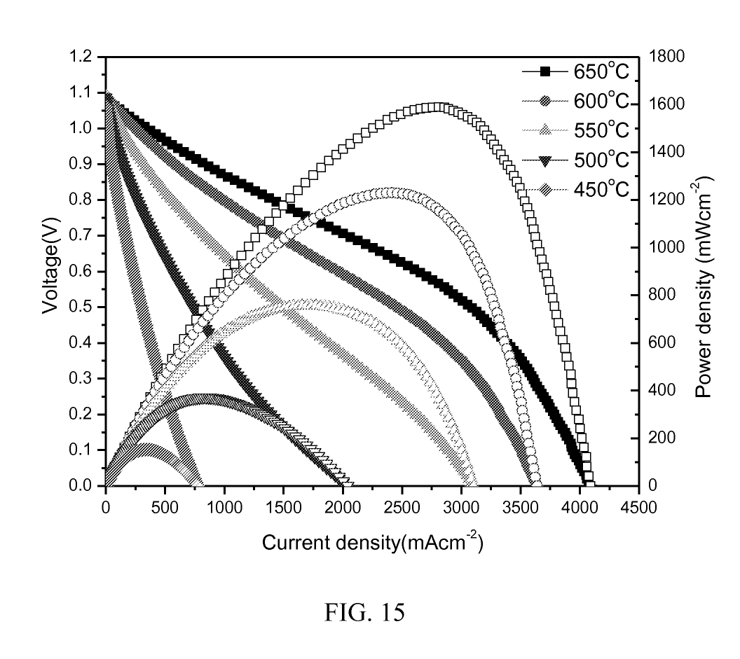

FIG. 15 shows exemplary plots of Voltage and power density versus current density at different temperatures. Maximum power density values increased with increasing temperature, exhibiting 1.6 Wcm⁻² at 650° C., 1.23 Wcm⁻² at 600° C., and 0.76 Wcm⁻² at 550° C.

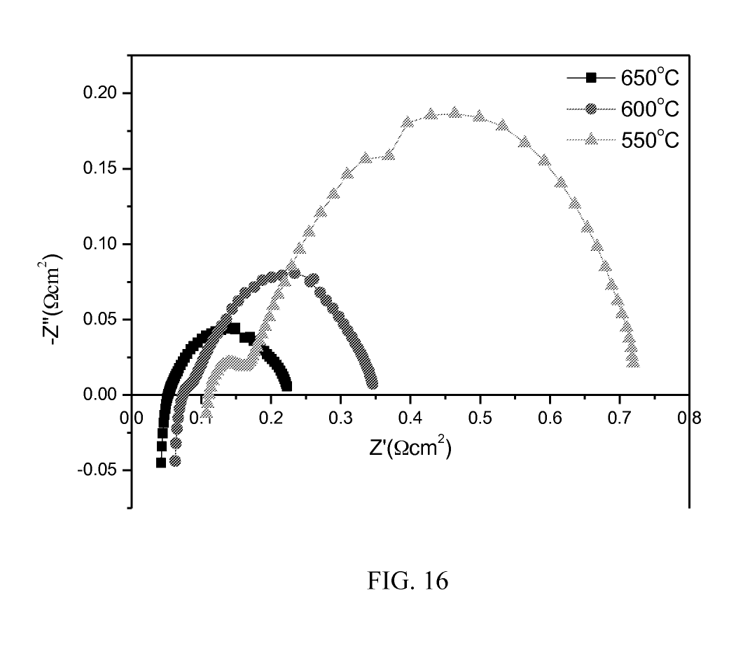

FIG. 16 shows exemplary Nyquist plots of impedance data taken at different temperatures for the most optimized cell. The total cell resistance reached as low as 0.22 Ωcm² at 650° C.

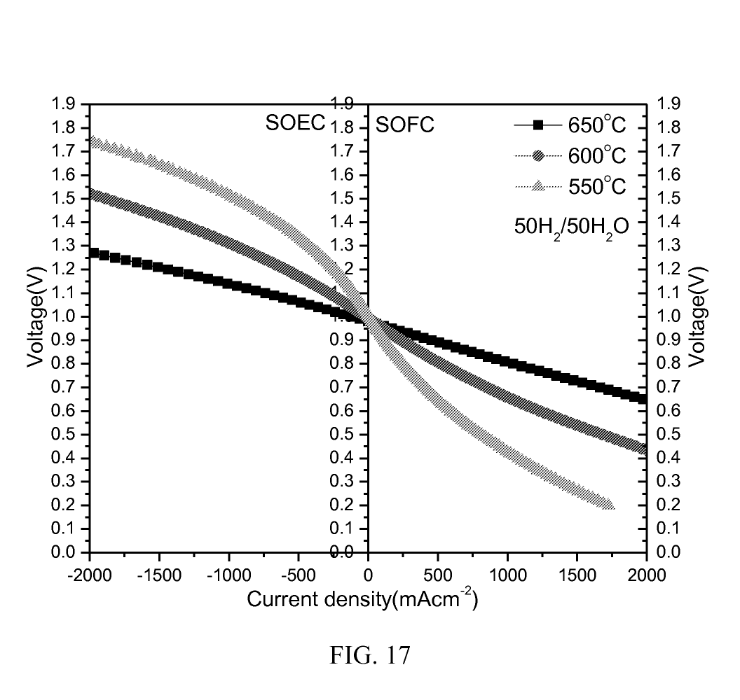

FIG. 17 shows exemplary plots of voltage versus current density at different temperatures in electrolysis and fuel cell modes, with air on one side and 50 vol.% H2/50 vol.% H2O on the other. The curve is fairly linear at 650° C., but show increased over-potentials and clear evidence of activated behavior at 600° C. and 550° C. The electrolysis voltage was 1.27V with 50 vol.% H2/50 vol.% H2O composition even under 2 Acm⁻² at 650° C.

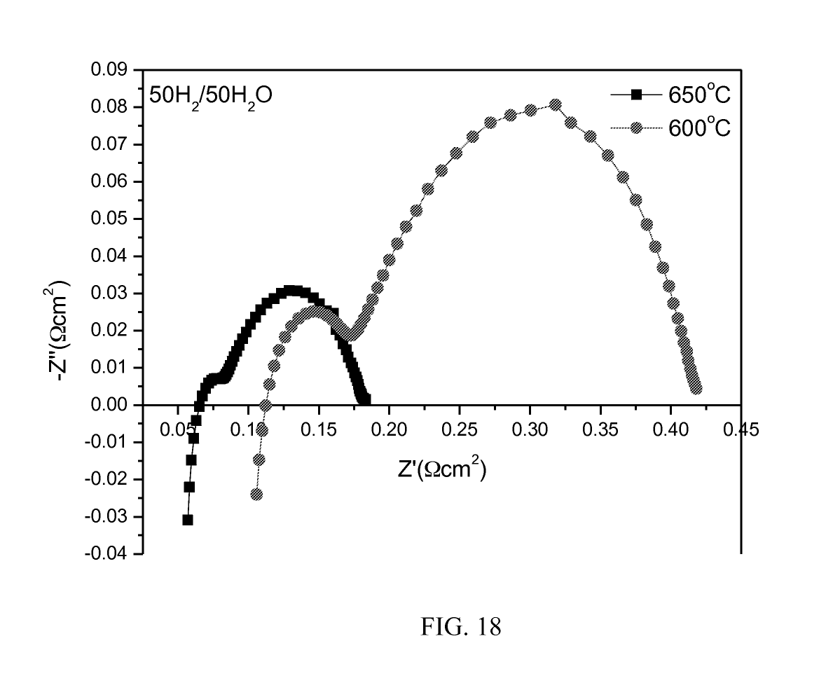

FIG. 18 shows exemplary Nyquist plots of impedance data for the optimized cell under electrolysis. The total cell resistance reached as low as 0.18 Ωcm² at 650° C. and 0.42 Ωcm² at 600° C.

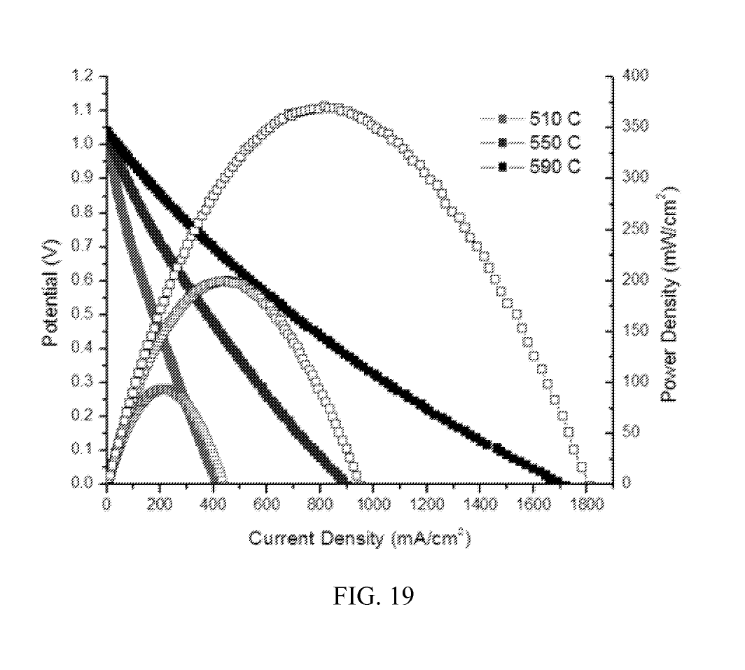

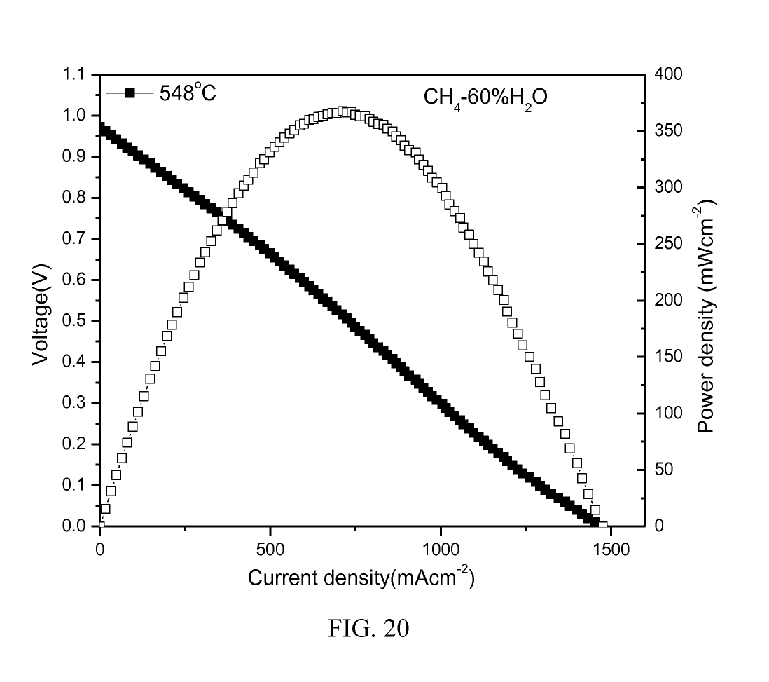

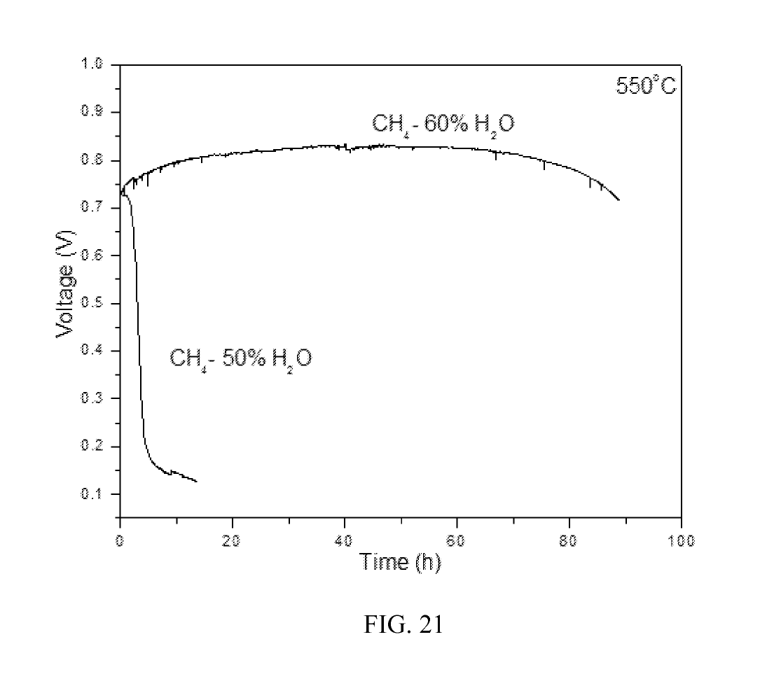

FIG. 19 shows exemplary plots of the IV and IP curves for a cell fuelled by CH₄(50%)-H₂O (50%) in the anode side. The maximum power density reached 375 mWcm⁻² at 590° C. and 200 mWcm⁻² at 550° C. When the composition changed to CH4(40%)-H2O(60%), the maximum power density increased to 375 mWcm-2 at 550° C. (FIG. 20). However, the cell can only be stable when the steam content is 60% to suppress the C coking at the anode side (FIG. 21).

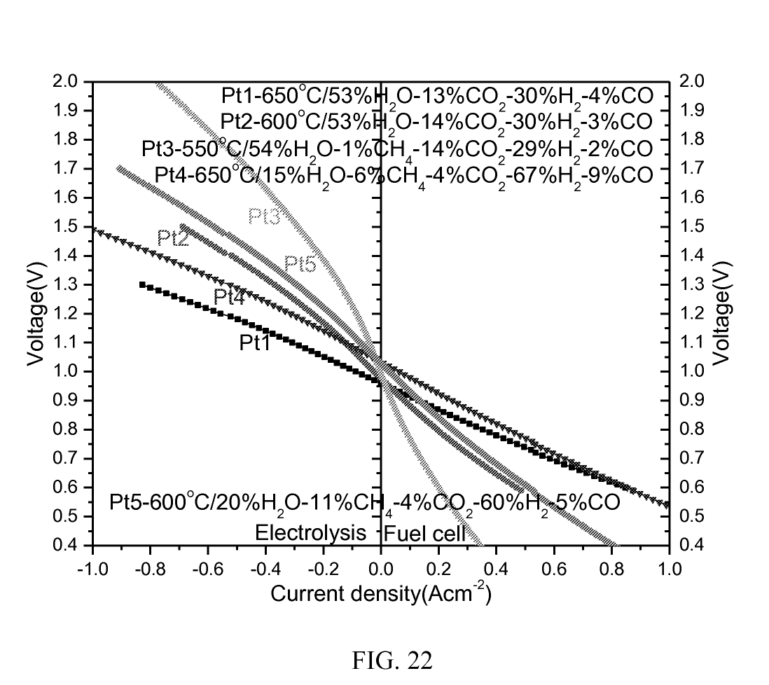

FIG. 22 presents an exemplary series of plots of the performance the electrolysis and fuel cell having different compositions. The electrochemical resistances are similar at same temperatures although the composition changed. However, when the temperature is decreased, the activation resistance became dominant. Note that these gas compositions are useful for the application of these cells for high efficiency electrochemical energy storage.

Preferred compositions include the following ingredients: H₂O in the range from about 15 wt. % to about 55 wt. %; CH4 in the range from about 0 wt. % to about 15 wt. %; CO₂ from about 3 wt. % to about 15 wt. %; H2 from about 30 wt. % to about 70 wt. %; and CO from about 1.5 wt. % to about 10 wt. %. Preferred operating temperatures for these fuel cells were within the range from about 550° C. to about 650° C. Exemplary compositions include those identified by formulations 1-5 presented in Table 1.

TABLE 1
Exemplary fuel cell compositions for a tape-
casted SOFC of the present invention.

| Formulation^{a} | H₂O | CH₄ | CO₂ | H₂ | CO |
|---|---|---|---|---|---|
| 1 | 53 wt. % | N/A | 13 wt. % | 30 wt. % | 4 wt. % |
| 2 | 53 wt. % | N/A | 14 wt. % | 30 wt. % | 3 wt. % |
| 3 | 54 wt. % | 1 wt. % | 14 wt. % | 29 wt. % | 2 wt. % |
| 4 | 15 wt. % | 6 wt. % | 4 wt. % | 67 wt. % | 9 wt. % |
| 5 | 20 wt. % | 11 wt. % | 4 wt. % | 60 wt. % | 5 wt. % |

^{a}Operating temperature for each fuel cell composition is as follows: Formulation 1: 650° C.; Formulation 2: 600° C.; Formulation 3: 550° C.; Formulation 4: 650° C.; and Formulation 5: 600° C.

Applications

In a first aspect, a low temperature operating solid oxide fuel cell (SOFC) is provided. By low temperature, the SOFC operates within a range from about 450° C. to about 650° C. The low temperature SOFC includes a Sr_{0.8}La_{0.2}TiO₃ (SLT) support layer;□ a (La_{0.9}Sr_{0.1})_{0.98}(Ga_{0.8}Mg_{0.2})O_{3-δ} (LSGM) electrolyte layer; and□a cathode layer on top of said electrolyte layer. In one respect, the first aspect can include a Ni—(La_{0.9}Sr_{0.1})_{0.98}Ga_{0.8}Mg_{0.2}O_{3-δ} (Ni-LSGM) anode functional layer (AFL) between the SLT support layer and LSGM electrolyte layer. In another respect, the first aspect includes a performance attribute having a low cell Ohmic resistance of ≦0.1 Ωcm². In another respect, the first aspect includes a performance attribute of maintaining a low electrode polarization resistance ≦0.2 Ωcm².

In a second aspect, a method of making a solid oxide fuel cell is provided. The method includes several steps. The first step is preparing an SLT powder via solid state reaction using SrCO₃, La₂O₃, and TiO₂ precursors. The second step includes dispersing the mixture in a suitable solvent carrier to obtain a homogeneous mixture. Examples of a suitable solvent carrier include organic polar protic solvents, such as alcohols. A preferred suitable solvent carrier includes ethanol. A suitable method of dispersing includes mixing. The third step includes subjecting the mixture to calcination at a temperature from about 950° C. to about 1200° C. A preferred calcination temperature is a temperature of about 950° C. A preferred incubation time at the calcination temperature will vary with conditions; a preferred calcination time is about 4 hours at a calcination temperature of about 950° C. The third step can further include a pre-calcination step, wherein the SLT material is dried. A fourth step includes mixing the SLT dried at 950° C. with graphite and poly(vinylbutyral) (PVB). Preferred amounts of graphite include about 20 wt. % and a preferred amount of PVB includes about 2 wt. %. Where the SLT is subjected to calcination at a temperature of about 1200° C., the SLT dried at 1200° C. is preferably mixed with about 33 wt. % graphite instead of 20 wt. % graphite. A fifth step includes dispersing in a suitable solvent carrier to obtain a homogeneous mixture. Examples of a suitable solvent carrier include organic polar protic solvents, such as alcohols. A preferred suitable solvent carrier includes ethanol. A preferred method of dispersing includes mixing. Additional processing steps include drying, grinding and sieving the SLT powder using a 120 mesh sieve. A pre-final processing step includes pressing the SLT product using a die. A preferred pressing includes dry pressing. A preferred dry pressing method includes uniaxially dry pressing. The final processing step is firing the dye-pressed SLT product. A preferred firing method includes bisque firing.

According to the foregoing respect of the second aspect, the method includes an additional method step of creating an anode functional layer (AFL). The method step includes providing a first colloidal solution that includes a LSGM powder, ethanol, polyethylenimine (PEI), PVB and ethyl cellulose; adding colloidal pore formers, such as graphite, tapioca starch, poly(methylmethacrylate) (PMMA) to the first colloidal solution;□dispersing first colloidal solution by agitation to form a second colloidal solution; coating the second colloidal solution onto one side of the bisque fired SLT pellet to form a porous functional layer; and firing the porous functional layer. A preferred method of agitating includes sonication, including other agitation methods known in the art. A preferred method of coating includes drop-coating, among other coating methods known in the art. A preferred temperature and incubation time for firing the porous functional layer includes about 1000° C. for about 1 hour.

According to the foregoing respect of the second aspect, the method includes an additional method step of creating an electrolyte layer. The method step includes: making a third colloidal solution of LSGM powder, ethanol, polyethylenimine (PEI), PVB and ethyl cellulose;□ dispersing the third colloidal solution by agitation to form a fourth colloidal solution;□coating fourth colloidal solution onto one side of the bisque fired SLT pellet to form an electrolyte layer; and□co-firing the resulting SLT/LSGM structures at a suitable firing temperature and incubation time. A preferred agitation method includes soniciation, among other agitation methods known in the art. A preferred coating method includes drop-coating, among other coating methods known in the art. A suitable firing temperature includes about 1400° C. and a suitable incubation time includes about 4 hours.

According to the foregoing respect of the second aspect, the method includes an additional method step of creating a cathode layer. The method includes the following steps: printing a 50 wt. % La_{0.3}Sr_{0.4}Fe_{0.8}Co_{0.2}O₃ (LSCF)/50 wt. % Ce_{0.9}Gd_{0.1}O₂(GDC) cathode functional layer ink onto the electrolyte layer;□printing of a pure LSCF cathode current collector ink; and firing the resulting layers at a suitable firing temperature and incubation period. A preferred printing method includes screen-printing. A preferred firing temperature include about 1100° C. for a preferred incubation time of about 2 hours.

According to the foregoing respect of the second aspect, the method includes an additional method step of infiltrating Ni into the SOFC. The method includes the following steps: infiltrating an Ni(NO₃)₂ solution into the SLT support and LSGM functional layer (when present) and calcining at a suitable calcination temperature and incubation time. A preferred Ni(NO₃)₂ solution includes a 5 M Ni(NO₃)₂ solution. A preferred calcination temperature and incubation time includes a calcination temperature of about 700° C. and incubation time of about 0.5 hr. In one respect, the desired Ni loading amount is achieved by performing multiple infiltration cycles. In another respect, an electro-catalytic metal other than Ni is used.

In a third aspect, a method of making a low temperature operating solid oxide fuel cell (SOFC) is provided. By low temperature, the SOFC operates within a range from about 450° C. to about 650° C. The low temperature SOFC includes a Sr_{0.8}La_{0.2}TiO₃ (SLT) support layer;□ a (La_{0.9}Sr_{0.1})_{0.98}(Ga_{0.8}Mg_{0.2})O_{3-δ} (LSGM) electrolyte layer; and□a cathode layer on top of said electrolyte layer. In one respect, the first aspect can include a Ni—(La_{0.9}Sr_{0.1})_{0.98}Ga_{0.8}Mg_{0.2}O_{3-δ} (Ni-LSGM) anode functional layer (AFL) between the SLT support layer and LSGM electrolyte layer. The method includes several steps. The first step includes preparing SLT powder via solid state reaction using SrCO₃, La₂O₃, and TiO₂ at a suitable calcination temperature and incubation period. A preferred calcination temperature includes a temperature of about 950° C. and a preferred incubation period includes about 4 hours. □The second step includes dispersing a mixture including the SLT, 30 wt. % graphite and a suitable solvent carrier, a solvent and a dispersant. A suitable solvent carrier includes organic polar protic solvents, such as alcohols. A preferred solvent carrier includes ethanol. A preferred solvent includes xylenes and a preferred dispersant includes fish oil. A preferred method of dispersing includes mixing. A preferred incubation time for dispersing by mixing is about 24 hrs. A third step includes dispersing the foregoing mixture in the presence of a suitable binder and plasticizer to form slurry. A preferred binder includes poly(vinylbutyral); preferred plasticizers include butyl benzyl phthalate (BBP) and Polyalkylene Glycol (PAG). A preferred dispersing method includes mixing for a suitable incubation time (such as, for example, 24 h). A fourth step includes casting the resultant slurry. A preferred method of casting includes tape casting. A fourth step includes mixing and dispersing the LSGM in the presence of graphite, a suitable solvent carrier, suitable solvent and suitable dispersant. A preferred about of graphite includes about 10 wt. % to about 40 wt. % graphite. A suitable carrier solvent includes an organic polar protic solvent, such as an alcohol. A preferred solvent carrier includes ethanol. A suitable solvent includes xylenes. A suitable dispersant includes fish oil. A fifth step includes dispersing the foregoing mixture in the presence of a suitable binder and plasticizer to form slurry. A preferred binder includes poly(vinylbutyral); preferred plasticizers include butyl benzyl phthalate (BBP) and Polyalkylene Glycol (PAG). A preferred dispersing method includes mixing for a suitable incubation time (such as, for example, 24 h). A fourth step includes casting the resultant slurry. A preferred method of casting includes tape casting. The resultant mixture is dispersed by mixing for an appropriate time (for example, 24 hr.). Ethanol, Xylenes as solvent and fish oil as dispersant, mixing for 24 h; adding□poly(vinylbutyral) as binder, butyl benzyl phthalate (BBP) and Polyalkylene□Glycol (PAG) as plasticizer, mixing/dispersing for 24 h. A pre-final step includes laminating the SLT-30 wt. % Graphite, LSGM—10-40 wt. % Graphite, LSGM together to form the final ceramic structure. An initial heating step is preformed with the prelaminate, wherein the prelaminate is heated at a temperature of about 80° C. The heat-treated prelaminate is then co-fired at a suitable firing temperature. An exemplary firing temperature includes a firing temperature of about 1425° C.

To complete the SOFC, additional steps of forming of cathode layer and infiltrating an electro-catalytic metal into the structure is performed. These additional steps are performed as described above. Likewise, in cases of dispersing mixtures as disclosed herein, mixing using ball milling is a preferred method of dispersing mixtures.

In a fourth aspect, a low temperature operating solid oxide fuel cell (SOFC) is provided. The SOFC includes a Sr_{0.8}La_{0.2}TiO₃ (SLT) support layer,□a (La_{0.9}Sr_{0.1})_{0.98}(Ga_{0.8}Mg_{0.2})O_{3-δ} (LSGM) electrolyte layer and□a cathode layer disposed on top of said electrolyte layer. The SLT support layer and LSGM electrolyte layer comprise a laminated, tape-casted ceramic structure. In one respect, the low temperature operating SOFC includes a composition comprising H₂O in the range from about 15 wt. % to about 55 wt. %; CH4 in the range from about 0 wt. % to about 15 wt. %; CO₂ from about 3 wt. % to about 15 wt. %; H₂ from about 30 wt. % to about 70 wt. %; and CO from about 1.5 wt. % to about 10 wt. %. In this respect, the low temperature operating SOFC comprises a composition selected from formulations 1-5:

| Formulation | H₂O | CH₄ | CO₂ | H₂ | CO |
|---|---|---|---|---|---|
| 1 | 53 wt. % | N/A | 13 wt. % | 30 wt. % | 4 wt. % |
| 2 | 53 wt. % | N/A | 14 wt. % | 30 wt. % | 3 wt. % |
| 3 | 54 wt. % | 1 wt. % | 14 wt. % | 29 wt. % | 2 wt. % |
| 4 | 15 wt. % | 6 wt. % | 4 wt. % | 67 wt. % | 9 wt. % |
| 5 | 20 wt. % | 11 wt. % | 4 wt. % | 60 wt. % | 5 wt. % |

In another respect, the SOFC operates at a temperature in the range from about 550° C. to about 650° C.

### EXAMPLES

The invention will be more fully understood upon consideration of the following non-limiting examples, which are offered for purposes of illustration, not limitation.

### Example 1

### Cell Fabrication

Two types of structures were prepared. The first consisted of a SLT anode support, LSGM electrolyte layer, and La_{0.6}Sr_{0.4}Fe_{0.8}Co_{0.2}O₃ (LSCF)/Ce_{0.9}Gd_{0.1}O₂ (GDC) cathode. The second structure was similar but included a porous LSGM anode functional layer (AFL) between the SLT support and LSGM electrolyte. In both cases, the anode support was infiltrated with Ni to complete the cell.

Sr_{0.8}La_{0.2}TiO₃ (SLT) powder was fabricated via solid-state reaction using SrCO₃, La₂O₃, and TiO₂ (Alfa Aesar, MA) precursors. Powders were mixed together in the appropriate weight ratio and ball milled in ethanol for 24 h, followed by drying and calcination at either 950 or 1,200° C. for 4 h, which were conditions chosen based on previous work [16, 17]. Phase purity was confirmed using X-ray diffraction (XRD). For the powder calcined at 1,200° C., 33 wt. % graphite (Timcal, Switzerland) was added. The SLT calcined at 950° C. was mixed with 20 wt. % graphite. In addition, 2 wt. % poly(vinyl butyral) (PVB) (Aldrich, WI) was added as a binder to each powder. The resulting powder was ball milled in ethanol for 24 h, dried, ground, and sieved using a 120 mesh sieve. Pellets of −0.6 g were uniaxially dry pressed using a 19 mm diameter die and then bisque fired using various temperature-time profiles as described below.

The LSGM functional layer and electrolyte layer were prepared by drop coating colloidal solutions onto one side of the bisque fired SLT pellet. For the colloidal solutions, (La_{0.9}Sr_{0.1})_{0.98}(Ga_{0.8}Mg_{0.2})O_{3-δ} (LSGM, Praxair, WA) powder was mixed with ethanol, polyethylenimine (PEl) as a dispersant, and a premixed binder solution containing PVB and ethyl cellulose. For the porous LSGM functional layer colloidal, pore formers such as graphite, tapioca starch, poly(methyl methacrylate) (PMMA), and PVB were added. The solutions were ball milled for 24 h. Before application, the colloidal solutions were briefly agitated either by ball milling or sonication to ensure that the particles were well-dispersed in the solution. In cases where a functional layer was used, an intermediate firing step of 1,000° C. for 1 h was performed between the application of the functional layer and the application of the electrolyte. The resulting SLT/LSGM structures were then co-fired at 1,400° C. for 4 h.

Cathode layers were prepared by screen printing a 50 wt. % La_{0.6}Sr_{0.4}Fe_{0.8}Co_{0.2}O₃ (LSCF, Praxair, WA)/50 wt. % Ce_{0.9}Gd_{0.1}O₂ (GDC, Nex Tech, OH) cathode functional layer ink onto the electrolyte, followed by a pure LSCF cathode current collector ink, as described previously [18]. The two resulting layers were fired at 1100° C. for 2 h. The effective area of the cathode was 0.5 cm².

Finally, an aqueous solution of 5 M Ni(NO₃)₂ (Fisher Chemicals, New Hampshire) was infiltrated into the porous SLT support and LSGM functional layer (when present), then calcined at 700° C. for 0.5 h. The desired Ni loading amount was achieved by performing multiple infiltration cycles.

In a separate process, LSCF/LSCF-GDC/LSGM/LSCF-GDC/LSCF cathode symmetric cells were fabricated by pressing LSGM pellets and then screen printing LSCF-GDC and LSCF layers on both sides using a procedure identical to that described above. These cells were used for an independent measurement of the cathode polarization resistance.

### Example 2

### Cell Testing

For testing, a silver current collector grid (Heraeus, PA) was screen printed on both the cathode and the anode sides of the fuel cell, followed by sealing to an alumina support tube using silver ink (DAD-87, Shanghai Research Institute) that also provided an electrical connection to the anode. The mounted cells were placed into horizontal testing furnaces, and the cathode was exposed to ambient air while the anode was exposed to humidified H₂ (3 vol.% H₂O). Cells were tested in the temperature range of 500-650° C. Electrochemical impedance spectroscopy (ElS) measurements were taken on an IM6 Electrochemical Workstation (ZAHNER, Germany). The frequency range used was 100 mHz to 100 kHz with an amplitude of 10 mV.

### Example 3

### Structural and Chemical Characterization

Scanning electron microscopy (SEM) and energy dispersive X-ray spectroscopy (EDS) were used to examine both tested and untested cells for microstructure and elemental distribution. Preliminary SEM images were taken on a Hitachi S-3400N-II. Higher resolution images were taken on a Hitachi SU8030 microscope equipped with an Oxford X-max 80 SDD EDS detector. The EDS data were analyzed using Oxford Instruments' INCA software package.

### Example 4

### Fabrication and Optimization of a Tape-Casted SOFC with Thin La_{0.8}Sr_{0.2}Ga_{0.8}Mg_{0.2}O_{3-δ} Electrolyte and Nano-Scaled Anode on Sr_{0.8}La_{0.2}TiO_{3-α} Support

Sr_{0.8}La_{0.2}TiO_{3-α} (SLT) powder for the anode support was prepared by solid state reaction method as described Example 1. Commercial La_{0.9}Sr_{0.1}Ga_{0.8}Mg_{0.2}O_{3-δ} (LSGM) powder (Praxair, Washington) was used for the electrolyte, and was mixed with 30 wt. % graphite for the anode functional layer in the same way that the SLT.

Anode half-cells were produced by tape casting, lamination, and co-firing. In this technique, raw anode and electrolyte powders are ball milled with a mixture of binders, plasticizers, dispersants, and solvents to produce a slurry. The slurry mixtures used in this work are a proprietary blend of ceramic powders with ethanol, xylenes, Menhaden fish oil, polyvinylbutyral (PVB), polyakylene glycol (PAG), and benzylbutylphthalate (BBP). An exemplary composition is shown in FIG. 12.

The slurries are then tape-cast onto thin plastic substrates using a doctor blade technique that allows for precise control of film thickness. After the tapes have dried, layers of anode and electrolyte are laminated together by hot isostatic pressing at 80-100° C. at a pressure of 5,000 psi for about 1 hour, and are then co-sintered. The co-sintering process takes place in two stages: a lower temperature stage at 600° C. where the organic binders and plasticizers burn out, leaving the ceramic components behind, and a higher temperature stage at 1425° C. that gives the cells their mechanical strength and densifies the electrolyte layer.

The cathode layer is applied via a screen-printing method, and the cell is sintered again at 1100° C. La_{0.6}Sr_{0.4}Fe_{0.8}Co_{0.2}O_{3-δ} (LSCF, Praxair, Washington) powder (50 wt. %) and Ce_{0.9}Gd_{0.1}O_{1.95} (GDC, Nextech, Ohio) powder (50 wt. %) were mixed together and dispersed into a vehicle (V-737, Heraeus Inc., Pennsylvania) by a three-roll mill. LSCF ink was prepared in the same way. The cathode consisting of LSCF-GDC as functional layer and LSCF as current collector was screen printed on the electrolyte and sintered at 1100° C. for 2 h. The active cathode surface area was 0.5 cm².

A 5 M Ni(NO₃)₂ (Fisher Chemicals, New Jersey) solution was infiltrated into the porous SLT support and LSGM functional layer. After calcining at 700° C. for 0.5 h, nanostructured NiO covered the SLT and LSGM surface homogeneously. The desired 30 wt. % NiO was achieved by 10-13 infiltration cycles (50 μL Ni(NO₃)₂ solution each cycle). The NiO was reduced to Ni metal during SOFC operation under humidified hydrogen (3 vol.% H₂O).

Current-voltage curves and electrochemical impedance spectroscopy measurements were conducted using the Zhaner IM6 electrochemical workstation. The cells were sealed onto an alumina tube with Ag ink (DAD-87, Shanghai Research Institute of Synthetic Resins) using a four-point probe configuration. The anode was fueled with three different fuel gas mixtures: 97% H₂ and 3% H₂O, 50% CH₄-50% H₂O, 40% CH₄-60% H₂O.

### REFERENCES

S. P. S. Badwal, S. Giddey, C. Munnings, A. Kulkami. “Review of Progress in High Temperature Solid Oxide Fuel Cell,” J. Austral. Ceramics Soc. 50:23-37 (2014).
[1] D. J. Brett, A. Atkinson, N. P. Brandon, S. J. Skinner, Chern. Soc. Rev. 2008, 37, 568.
[2] D. M. Bierschenk, J. R. Wilson, S. A. Barnett, Energy Environ. Sci. 2011, 4, 944.
[3] Y. Lin, S. A. Barnett, Electrochem. Solid-State Lett. 2006, 9, A285.
[4] Y. B. Kim, J. S. Park, T. M. Giir, F. B. Prinz,]. Power Sources 2011, 196, 10550.
[5] J. M. Vohs, R. J. Gorte, Adv. Mater. 2009, 21, 943.
[6] Z. Zhan, D. M. Bierschenk, J. S. Cronin, S. A. Barnett, Energy Environ. Sci. 2011, 4, 3951.
[7] Z. Zhan, D. Han, T. Wu, X. Ye, S. Wang, T. Wen, S. Cho, S. A. Barnett, RSC Adv. 2012, 2, 4075.
[8] U.S. Geological Survey 2011.
[9] W. Z. Zhu, S. C. Deevi, Mater. Sci. Eng., A 2003, 362, 228.
[10] O. A. Marina, N. L. Canfield, J. W. Stevenson, Solid State Ionics 2002, 149, 21.
[11] H. Ullman, N. Trofimenko, F. Tietz, D. Stoever, A. Ahmad-Khanlou, Solid State Ionics 2000, 138, 79.
[12] S. Hashimoto, L. Kindermann, F W. Poulsen, M. Mogensen, J. Alloys Compd. 2005, 397, 245.
[13] S. Hashimoto, L. Kindermann, P H Larsen, F. W. Poulsen, M. Mogensen, J. Electroceram. 2006, 16, 103.
[14] M. D. Gross, J. M. Vohs, R. J. Gorte, Electrochem. Solid-State Lett. 2007, 10, B65.
[15] M. R. Pillai, Y. Jiang, N. Mansourian, I. Kim, D. M. Bierschenk, H. Zhu, R. J. Kee, S. A. Barnett, Electrochem. Solid-State Lett. 2008, 11, B174.
[16] M. R. Pillai, I. Kim, D. M. Bierschenk, S. A. Barnett, J. Power Sources 2008, 185, 1086.
[17] A. Vincent, J.-L. Luo, K. T. Chuang, A. R Sanger,]. Power Sources 2010, 195, 769.
[18] P. Von Dollen, S. Barnett, J. Am. Ceram. Soc. 2005, 88, 3361.
[19] K. Huang, J.-H. Wan, J. B. Goodenough, J. Electrochem. Soc. 2001, 148, A788.
[20] J. M. Haag, D. M. Bierschenk, S. A. Barnett, K. R Poeppelmeier, Solid State Ionics 2012, 212, 1.
[21] U. Balachandran, N. G. Eror, J. Electrochem. Soc. 1982, 129, 1021.

### INCORPORATION BY REFERENCE

All patents, patent applications, patent application publications and other publications cited herein are hereby incorporated by reference as if set forth in their entirety.

It should be understood that the methods, procedures, operations, composition, and systems illustrated in figures may be modified without departing from the spirit of the present disclosure. For example, these methods, procedures, operations, devices and systems may comprise more or fewer steps or components than appear herein, and these steps or components may be combined with one another, in part or in whole.

Furthermore, the present disclosure is not to be limited in terms of the particular embodiments described in this application, which are intended as illustrations of various embodiments. Many modifications and variations can be made without departing from its scope and spirit. Functionally equivalent methods and apparatuses within the scope of the disclosure, in addition to those enumerated herein, will be apparent to those skilled in the art from the foregoing descriptions.

The invention claimed is:

1. A low temperature operating solid oxide fuel cell (SOFC), comprising:
a Sr_{0.8}La_{0.2}TiO₃ (SLT) support layer;□
a (La_{0.9}Sr_{0.1})_{0.98}(Ga_{0.8}Mg_{0.2})O_{3-δ} (LSGM) electrolyte layer; and□
a cathode layer disposed on top of said electrolyte layer.

2. The SOFC of claim 1, wherein the LSGM electrolyte layer includes a
Ni—(La_{0.9}Sr_{0.1})_{0.98}Ga_{0.8}Mg_{0.2}O_{3-δ} (Ni-LSGM) anode functional layer (AFL) disposed between the SLT support layer and LSGM electrolyte layer.

3. The SOFC of claim 1, wherein the SOFC comprises a performance attribute having a low cell Ohmic resistance of ≦0.1 Ωcm².

4. The SOFC of claim 1, wherein the SOFC comprises a performance attribute of maintaining a low electrode polarization resistance ≦0.2 Ωcm².

5. A method of making a solid oxide fuel cell, comprising:
preparing an SLT powder via solid state reaction using SrCO₃, La₂O₃, and TiO₂ precursors to form a calcinated SLT product;□
dispersing the calcinated SLT powder with graphite and poly(vinylbutyral) (PVB) to form a homogeneous mixture;
drying the homogenous mixture to form a dried product;
pressing the dried product using a die; and
bisque firing the pressed product.

6. The method of claim 5, further comprising the steps of creating an anode functional layer (AFL), comprising:
preparing a first colloidal solution comprising LSGM powder, ethanol, polyethylenimine (PEI), PVB and ethyl cellulose;□
preparing a second colloidal solution comprising the first colloidal solution and a colloidal pore former;□
dispersing the second colloidal solution;
coating said colloidal solution onto one side of the bisque fired SLT pellet to form a porous functional layer; and
firing the porous functional layer.

7. The method of claim 6, further comprising the steps of creating an electrolyte layer, comprising:
preparing a dispersed colloidal solution comprising LSGM powder, ethanol, polyethylenimine (PEI), PVB and ethyl cellulose;□
coating the dispersed colloidal solution onto one side of the bisque fired SLT pellet to
form an electrolyte layer; and□
co-firing the resulting SLT/LSGM structures.

8. The method of claim 7, further comprising the steps of creating a cathode layer, comprising:
printing a 50 wt. % La_{0.3}Sr_{0.4}Fe_{0.8}Co_{0.2}O₃ (LSCF)/50 wt. % Ce_{0.9}Gd_{0.1}O₂ (GDC) cathode functional layer ink onto the electrolyte layer;□
printing of a pure LSCF cathode current collector ink; and
firing the resulting layers.

9. The method of claim 5, wherein dispersing comprising ball milling.

10. The method of claim 5, further comprising the steps:
infiltrating an electro-catalytic metal into the SLT support and LSGM functional layer to form an electro-catalytic metal-infiltrated structure;□and
calcining the electro-catalytic metal-infiltrated structure.

11. The method of claim 10, wherein the electro-catalytic metal comprises Ni.

12. The method of claim 11, wherein infiltrating Ni performing multiple infiltration cycles.

13. The method of claim 10, where an electro-catalytic metal comprises a metal other than Ni.

14. A method of making the solid oxide fuel cell of claim 1, comprising:
preparing an SLT powder product via solid state reaction using SrCO₃, La₂O₃, and TiO₂;□
dispersing a mixture comprising the SLT powder product, graphite, a solvent carrier, a solvent and a dispersant;
forming a first slurry comprising the mixture, a binder and a plasticizer;
tape-casting the first slurry;
dispersing a mixture comprising the LSGM, graphite, a solvent carrier, a solvent and a dispersant;
forming a second slurry comprising the mixture, a binder and a plasticizer;
tape-casting the second slurry;
laminating the first slurry and second slurry together to produce the final ceramic□structure; and
forming a cathode layer.

15. The method of claim 14, wherein the laminating comprises:
heating the first and second slurries together at a first temperature; and
co-firing the first and second slurries together at a second temperature.

16. The method of claim 14, wherein the binder comprises poly(vinylbutyral) and the plasticizer comprises butyl benzyl phthalate (BBP) and polyalkylene glycol (PAG).

17. A low temperature operating solid oxide fuel cell (SOFC), comprising:
a Sr_{0.8}La_{0.2}TiO₃ (SLT) support layer;□
a (La_{0.9}Sr_{0.1})_{0.98}(Ga_{0.8}Mg_{0.2})O_{3-δ} (LSGM) electrolyte layer; and□
a cathode layer disposed on top of said electrolyte layer,
wherein the SLT support layer and LSGM electrolyte layer comprise a laminated, tape-casted ceramic structure.

18. The low temperature operating solid oxide fuel cell (SOFC) of claim 17, wherein the low temperature operating SOFC comprises a composition comprising H₂O in the range from about 15 wt. % to about 55 wt. %; CH4 in the range from about 0 wt. % to about 15 wt. %; CO₂ from about 3 wt. % to about 15 wt. %; H₂ from about 30 wt. % to about 70 wt. %; and CO from about 1.5 wt. % to about 10 wt. %.

19. The low temperature operating solid oxide fuel cell (SOFC) of claim 18, wherein the low temperature operating SOFC comprises a composition selected from formulations 1-5:

| Formulation | H₂O | CH₄ | CO₂ | H₂ | CO |
|---|---|---|---|---|---|
| 1 | 53 wt. % | N/A | 13 wt. % | 30 wt. % | 4 wt. % |
| 2 | 53 wt. % | N/A | 14 wt. % | 30 wt. % | 3 wt. % |
| 3 | 54 wt. % | 1 wt. % | 14 wt. % | 29 wt. % | 2 wt. % |
| 4 | 15 wt. % | 6 wt. % | 4 wt. % | 67 wt. % | 9 wt. % |
| 5 | 20 wt. % | 11 wt. % | 4 wt. % | 60 wt. % | 5 wt. % |

20. The low temperature operating solid oxide fuel cell (SOFC) of claim 18, wherein the SOFC operates at a temperature in the range from about 550° C. to about 650° C.
